(19) United States
(12) Patent Application Publication
(10) Pub. No.: US 2017/0123333 A1
(43) Pub. Date: May 4, 2017

(54) TONER

(71) Applicant: CANON KABUSHIKI KAISHA, Tokyo (JP)

(72) Inventors: Shiro Kuroki, Suntou-gun (JP); Kazumi Yoshizaki, Suntou-gun (JP); Kenichi Nakayama, Numazu-shi (JP); Yuujirou Nagashima, Susono-shi (JP); Takeshi Kaburagi, Suntou-gun (JP)

(21) Appl. No.: 15/333,297

(22) Filed: Oct. 25, 2016

(30) Foreign Application Priority Data
Oct. 28, 2015 (JP) 2015-212354

(51) Int. Cl. G03G 9/087; G03G 9/09

(52) U.S. Cl. CPC G03G 9/08708; G03G 9/08755; G03G 9/08711; G03G 9/0918

(57) ABSTRACT

A toner comprising a toner particle containing a binder resin, a colorant and a crystalline resin, wherein the loss elastic modulus G″ of the toner at 20° C. is 1.5×10⁸ Pa to 1.0×10⁹ Pa, a shoulder appears at a temperature Tp (° C.) in the range of 30° C. to 45° C. in a temperature-loss elastic modulus curve, and, in Curve 1 obtained by differentiating the temperature-loss elastic modulus curve once by the temperature, the minimum value of the Curve 1 in the range of 60° C. or more is −0.30 to −0.15.

### BACKGROUND OF THE INVENTION

Field of the Invention

The present invention relates to a toner for use in electrophotographic methods, electrostatic recording methods and toner jet methods.

Description of the Related Art

Means of outputting even higher resolution full color images have been in demand in recent years, and interest has focused in particular on energy saving, which is now recognized as a vital quality of toners. One way to save energy with a toner is to fix the toner at a lower temperature, and there are various approaches to this problem involving toner materials. One approach is a technique of including a crystalline material in the toner, which is an effective means of achieving low-temperature toner fixation.

Japanese Patent Application Publication No. 2010-139659 discloses a technique for improving low-temperature fixability, image glossiness and filming resistance by including a composite resin comprising a styrene-based resin component and a polycondensed resin component in the toner.

WO 2006/135041 discloses a technique for achieving both low-temperature fixability and offset resistance by means of a toner binder resin comprising an amorphous resin (Z) and a hybrid resin of a crystalline resin (X) and an amorphous resin (Y).

Japanese Patent Application Publication No. H2-294659 discloses a technique wherein a block copolymer or graft copolymer obtained by chemically bonding a crystalline polyester and an amorphous vinyl polymer is used as a binder. It also discloses that a toner with good flowability, blocking resistance, low-temperature fixability and offset resistance as well as excellent durability can be provided by this technique.

Japanese Patent Application Publication No. 2009-63969 discloses a technique relating to a toner manufactured by polymerization using a peroxide-based polymerization initiator in an aqueous medium in the presence of a polymerizable monomer and a crystalline polyester resin. Development durability can be improved and a toner with excellent low-temperature fixability and offset resistance can be obtained with this technique.

However, there is further room for improvement not only in energy savings but also in the areas of durability, storage stability, image quality and tinting strength.

### SUMMARY OF THE INVENTION

When a crystalline material such as an ester wax or crystalline polyester is added to a toner, the viscosity of the toner declines abruptly in the temperature range at and above the melting point of the crystalline material. This occurs because the crystalline material melts rapidly, plasticizing the binder resin in the toner. In comparison with ester waxes, crystalline resins such as crystalline polyesters can be designed with a wider range of resin characteristics including acid number and molecular weight. It is thus possible to design these resins with an eye towards improved dispersibility and compatibility with the binder resin of the toner, allowing for even greater plasticization effects. The inventors in this case attempted to make full use of the plasticization effects of crystalline resins.

It is thought that to fully exploit the plasticization effect of a crystalline resin on a toner, it is necessary to include a certain amount of a low-melting-point component in the crystalline resin. However, if the content of a crystalline resin containing a low-melting-point component is increased in a toner, the low-melting-point component is likely to be exposed on the surface of the toner, which can increase the likelihood of charge leaks and cause problems of triboelectric charging instability. Heat resistance may also decline, and in some cases sufficient durability performance has not been obtained in developing systems in which a load is applied to the toner.

It is an object of the present invention to resolve these problems. In other words, the object is to provide a toner having an added crystalline resin, the toner exhibiting adequate low-temperature fixability even during high-speed fixation, and having adequate durability performance even in developing systems in which a load is applied to the toner. Another object is to provide a toner having adequate storage stability and durability performance even in high-temperature, high-humidity environments.

To resolve these problems, the inventors arrived at the present invention as a result of exhaustive research into toner design for achieving heat resistance and durability performance equivalent to or greater than that of prior art even when using a crystalline resin containing a low-melting-point component, after discovering that this could be achieved by establishing specific conditions for viscoelasticity behavior.

That is, the present invention is a toner including a toner particle containing a binder resin, a colorant and a crystalline resin, wherein

in viscoelasticity measurement in which the toner is heated from 20° C. to 120° C. at a ramp rate of 2.0° C./minute, the loss elastic modulus G″ of the toner at 20° C is 1.5×10⁹ Pa to 1.0×109 Pa,

in a temperature-loss elastic modulus curve obtained by plotting a temperature (° C.) on the abscissa and the common logarithm (LogG″) of a value obtained by dividing the loss elastic modulus G″ of the toner by a loss elastic modulus unit (Pa) on the ordinate, a shoulder appears at a temperature Tp in a range of 30° C. to 45° C., and

in Curve 1 obtained by differentiating the temperature-loss elastic modulus curve once by the temperature, a minimum value of the Curve 1 in a range of 60° C. or more is −0.30 to −0.15.

The present invention can provide a toner with a crystalline resin added thereto, wherein the toner exhibits excellent low-temperature fixability and has adequate durability performance even in developing systems in which a load is applied to the toner. It can also provide a toner exhibiting good storage stability and durability performance even in high-temperature, high-humidity environments.

### BRIEF DESCRIPTION OF THE DRAWINGS

FIG. 1 shows one example of a temperature-loss elastic modulus curve;

FIG. 2A and FIG. 2B show examples of a primary differential curve (Curve 1) and a secondary differential curve (Curve 2) of a temperature-loss elastic modulus curve, respectively;

FIG. 3A and FIG. 3B each show an example of a device for drying;

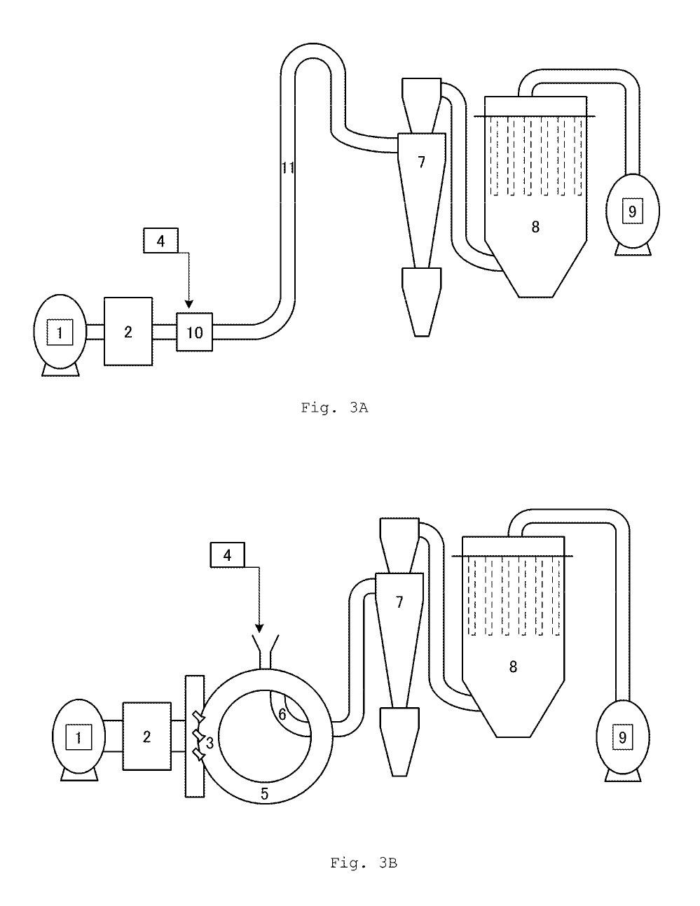

FIG. 4 is a cross-sectional explanatory drawing of a process cartridge; and

FIG. 5 shows one example of an image-forming unit.

### DESCRIPTION OF THE EMBODIMENTS

The present invention is explained in detailed below by giving embodiments of the invention.

The toner of the invention contains a crystalline resin.

Crystalline resins are more thermally responsive than amorphous resins, maintaining their strength adequately at temperatures below the melting point, but then melting and abruptly losing elasticity when a specific temperature is reached (this is called a sharp melt property). When applied to a toner, this characteristic allows good low-temperature fixability to be achieved without detracting from the flowability and strength of the toner.

### [Viscoelastic Properties]

The toner of the invention has the following features in viscoelasticity measurement in which the toner is heated from 20° C. to 120° C. at a rate of 2.0° C./minute.

As the first feature relating to the viscoelastic properties, the loss elastic modulus G″ of the toner at 20° C. is 1.5×10⁸ Pa to 1.0×10⁹ Pa.

When the loss elastic modulus G″ of the toner at 20° C. is within this range, a good sharp melt property is obtained, and the toner has adequate storage stability and durability at room temperature. Methods for controlling the loss elastic modulus G″ of the toner at 20° C. within this range include adjusting the molecular weight of the binder resin, adjusting the added amount of the crystalline resin and controlling the degree of crystallinity of the crystalline resin in the toner. In a toner with a core-shell structure, it can be controlled by adjusting the added amount of the surface layer resin.

Preferably, the loss elastic modulus G″ of the toner at 20° C. is 2.0×10⁸ Pa to 7.0×10⁸ Pa.

The second feature relating to the viscoelastic properties is that, in a temperature-loss elastic modulus curve obtained by plotting the temperature on the abscissa and the common logarithm (LogG″) of a value obtained by dividing the loss elastic modulus G″ of the toner by the loss elastic modulus unit (Pa) on the ordinate, a shoulder appears at a temperature Tp (° C.) in the range of 30° C. to 45° C.

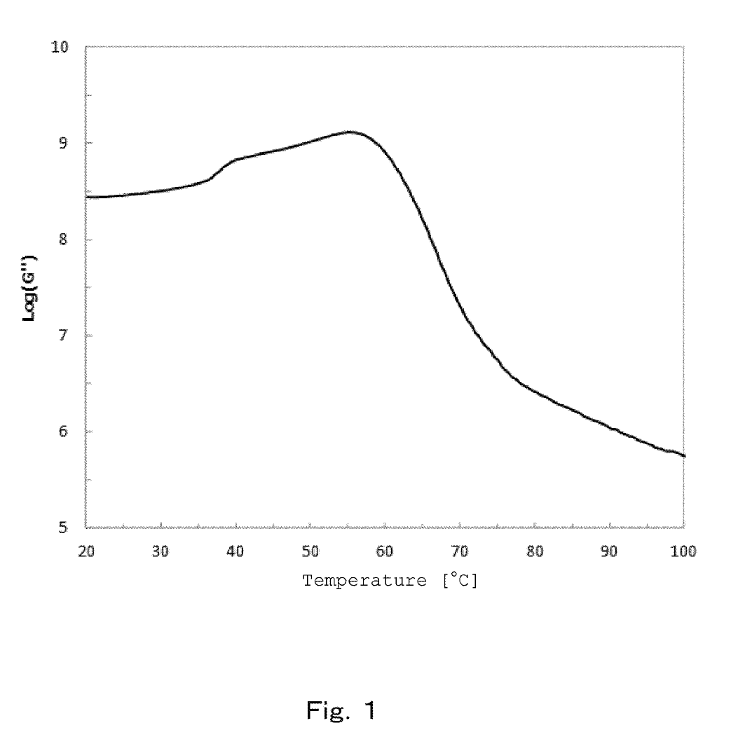

An example of a temperature-loss elastic modulus curve exhibiting a shoulder in the range of 30° C. to 45° C. is shown in FIG. 1.

More specifically, it is considered that “a shoulder appears at a temperature Tp (° C.)” if all of conditions (1) to (4) below are met.

(1) In a “Curve 1” obtained by differentiating the temperature-loss elastic modulus curve (obtained by plotting the temperature on the abscissa and the common logarithm (LogG″) of a value obtained by dividing the loss elastic modulus G″ of the toner by the loss elastic modulus unit (Pa) on the ordinate) once by the temperature, a maximal value appears at a temperature Tp (C °) in the range of 30° C. to 45° C.

(2) In “Curve 2” obtained by differentiating the temperature-loss elastic modulus curve twice by the temperature, a minimal value occurs at a temperature Ts in the range of Tp+0.1 (° C.) to Tp+10 (° C.).

(3) The value of Curve 1 at temperature Tp (° C.) is 0.03 or more.

(4) The value of Curve 2 at temperature Ts (° C.) is −0.01 or less.

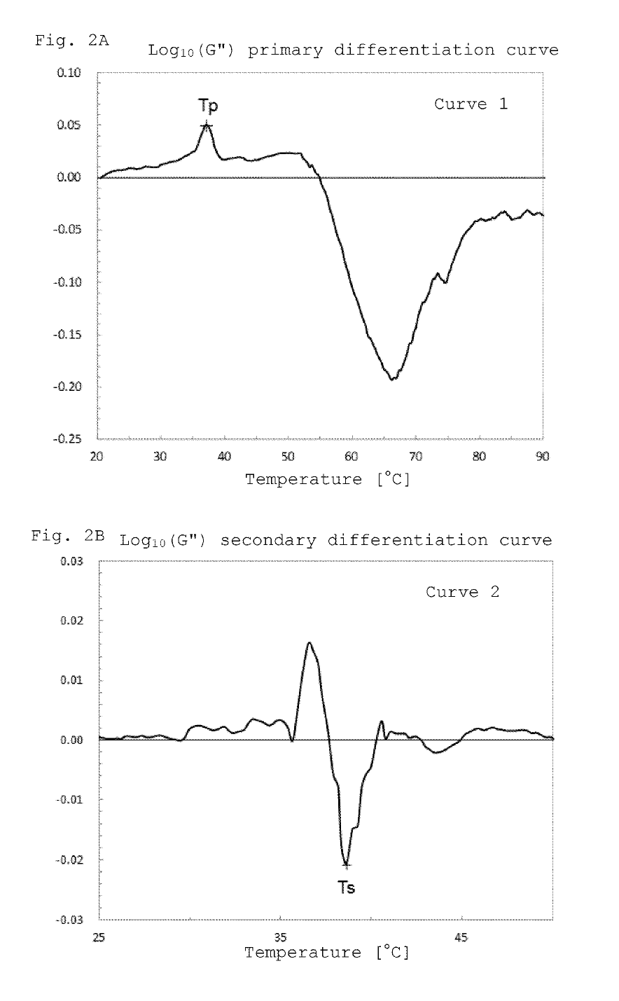

A conceptual view of the maximal value of Curve 1 in the range of 30° C. to 45° C. is shown in FIG. 2A, while a conceptual view of the minimal value of Curve 2 in the range of Tp+0.1 (° C.) to Tp+10 (+ C.) is shown in FIG. 2B.

The means of obtaining Curve 1 is explained here. Counting from a measurement initiation temperature 20° C. to the highest temperature, the nth measurement temperature is defined as Tₙ (° C.). The displacement in the temperature-loss elastic modulus curve between Tₙ (° C.) and Tₙ₊₁ (° C.) is defined as the differential value at Tₙ (° C.). The differential values are calculated for all temperature regions, then the temperatures are plotted on the abscissa and the differential values are plotted on the ordinate, and the points are connected smoothly to obtain Curve 1.

The same methods used in preparing Curve 1 above may be used similarly for Curve 2.

Because irregular measurement values often occur due to noise in viscoelasticity measurement, viscoelasticity measurement was performed 5 times for each sample, and a shoulder was recognized only when all five measurements fulfilled conditions (1) to (4) above.

In a toner manufactured with an aim to improving low-temperature fixability, the central glass transition temperature of the binder resin (hereunder sometimes represented simply as “Tg”) may be a low temperature of 45° C. or less. In such a toner, molecular movement of the binder resin occurs in high-temperature environments of 30° C. or more, softening the binder resin and detracting from the mechanical strength of the toner.

In the toner of the invention, however, the existence of a temperature Tp (° C.) exhibiting a shoulder in the range of 30° C. to 45° C. means that the mechanical strength of the toner is improved in this temperature range.

The mechanism by which this occurs is thought to be as follows.

It is thought that the crystalline resin, which is finely dispersed in the binder resin, is fixed and does not move at normal temperatures. Of the crystalline resin fixed in the binder resin, the part of the low-melting-point component that was in an amorphous state in the toner of the invention begins to move at the temperature range described above, forming crystals and promoting phase separation between the binder resin and the crystalline resin. The degree of crystallinity of the crystalline resin increases as a result, and it is thought that this increases mechanical strength. The low-melting-point component of the crystalline resin here is the component with a fusion-initiation temperature of 50° C. or less.

It is thus possible not only to improve the low-temperature fixability of the toner, but also to minimize loss of storage stability and durability in high-temperature environments.

Methods of obtaining a shoulder at 30° C. to 45° C. are for example:

(1) adjusting the amount of the low-melting-point component with a fusion-initiation temperature of 50° C. or less in the crystalline resin;

(2) adjusting the heating temperature or heating time during toner manufacture to thereby regulate the blended state of the crystalline resin and binder resin;

(3) including an annealing process during toner manufacture, and adjusting the annealing holding time and holding temperature to thereby control the degree of crystallinity of the crystalline resin;

(4) adjusting the drying temperature conditions and drying time when the toner is manufactured by a wet process.

When no shoulder is present in the temperature-loss elastic modulus curve in the range of 30° C. to 45° C., the storage stability of the toner may decline as the binder resin softens in high-temperature environments. The solubility of the crystalline resin in the binder resin is also likely to decline, and fogging is likely to increase due to reduced dispersibility of toner particle components such as the colorant and crystalline resin.

The temperature Tp at which the shoulder occurs is preferably from 33° C. to 42° C.

The third feature relating to the viscoelastic properties is that in Curve 1 obtained by differentiating the temperature-loss elastic modulus curve once by the temperature, the minimum value of the Curve 1 in the range of 60° C. or more is −0.30 to −0.15.

The minimum value of the Curve 1 in the temperature range of 60° C. or more represents the minimum value of the slope of the temperature-loss elastic modulus curve. That is, when this value is a small negative number it means that the viscosity loss speed during fixing heating is high. In other words, this means that it is possible to obtain a toner with a greater sharp melt property and excellent low-temperature fixability.

The toner used in the invention contains a crystalline resin, and the following are considered to be desirable for obtaining a greater sharp melt property:

(1) the crystalline resin is finely dispersed in the binder resin;

(2) the percentage of molecules forming crystalline states in the binder resin is at least a certain percentage;

(3) there is a high degree of affinity between the crystalline resin and the binder resin (near the SP value).

When conditions such as these have been met, the crystalline resin and binder resin can be blended instantaneously when the crystalline resin is melted during the fixing process, resulting in thorough plasticization of the binder resin. It is thus possible to control the minimum value of the Curve 1 at a low value at a temperature range of 60° C. or more.

The minimum value of the Curve 1 at a temperature range of 60° C. or more can be controlled by adjusting the melting point of the added crystalline resin, the added amount of the crystalline resin, the degree of crystallinity of the crystalline resin, and the difference in SP values between the crystalline resin and the binder resin. The minimum value of the Curve 1 is preferably −0.30 to −0.20.

In the aforementioned viscoelasticity measurement, the loss elastic modulus G″ of the toner preferably exhibits a maximum value in the temperature range of 48.0° C. to 62.0° C. (more preferably 50.0° C. to 59.0° C.). This maximum value is preferably 6.0×10⁸ Pa to 3.0×10⁹ Pa, or more preferably 8.0×10⁸ Pa to 2.0×10⁹ Pa. The balance of heat resistance, durability and low-temperature fixability in the toner is further improved when the maximum value of the loss elastic modulus G″ occurs at a temperature within this range, and the value is also within the aforementioned range.

The temperature at which the maximum value of the loss elastic modulus G″ occurs can be achieved by controlling the Tg of the toner and the added amount of the crystalline resin.

The maximum value of the loss elastic modulus G″ can be controlled by adjusting the molecular weight of the toner.

The crystalline resin used in the present invention preferably has a melting point Tm (C) of 55.° C. to 85.0° C.

The melting point Tm (C) of the crystalline resin in the present invention is the endothermic peak top temperature in differential scanning calorimetry (DSC). In the present invention, heat resistance and fixability can be maintained if the Tm (C) is 55.0° C. to 85.0° C. This is also desirable because solubility with the polymerizable monomer is increased when the toner particle is manufactured by a polymerization method. The crystalline resin can also maintain a crystal state without melting in the toner particle even in high-temperature environments, and the finely dispersed crystalline resin in the toner particle can then melt rapidly even under high-speed fixing conditions. It is thus possible to obtain good heat-resistant storability and low-temperature fixability. A preferred range of Tm (C) is 60.0° C. to 85.0° C.

The Tm (C) can be regulated by adjusting the types and degree of polymerization and the like of the alcohol monomer or carboxylic acid monomer used in the raw materials of the crystalline resin.

Preferably in the toner of the present invention the ratio of the endothermic peak area at 50° C. or less to the endothermic main peak area of the crystalline resin is 2.0% to 20.0%, or more preferably 2.5% to 15.0% in a DSC curve obtained by differential scanning calorimetry.

The endothermic peak component at 50° C. or less represents the crystalline resin component with a melting point of 50° C. or less. If a component with a melting point of 50° C. or less is contained in this amount, compatibility between the crystalline resin and binder resin is further improved, and low-temperature fixability is further improved during high-speed printing.

The ratio of the endothermic peak area at 50° C. or less to the endothermic peak area of the main peak of the crystalline resin can be controlled by controlling the melting point of the crystalline resin, the polymerization temperature and other conditions, or the acid value and molecular weight of the crystalline resin. It can also be controlled by having the crystalline resin be a hybrid resin having crystalline segments (preferably crystalline polyester segments) and amorphous vinyl segments, and adjusting the mass ratio (crystalline segments/amorphous segments) of the crystalline segments and amorphous vinyl segments in the crystalline resin.

When adjusting the mass ratio of the crystalline polyester segments and amorphous vinyl segments in the crystalline resin, a preferable range of the mass ratio (crystalline polyester segments/amorphous vinyl segments) is 70/30 to 98/2. When the crystalline resin has amorphous vinyl segments, compatibility is improved . between the binder resin and these amorphous vinyl segments of the crystalline resin, and the crystalline resin can be more finely dispersed in the toner than in the past. One advantage of this is that excellent low-temperature fixability and durability can be obtained in this way.

In particular, a method of purifying the crystalline resin by re-precipitation can be used to control the ratio of the endothermic peak area at 50° C. or less within a narrow range of 2.0% to 20.0%.

The materials contained in the toner are explained next.

### [Crystalline Resin]

The crystalline resin is not particularly limited, but is preferably a crystalline polyester resin or a hybrid resin having crystalline polyester segments and amorphous vinyl segments. The crystalline polyester segments or crystalline polyester resin is preferably obtained by a reaction between a bivalent or higher polyvalent carboxylic acid and a diol. A polyester produced by an aliphatic diol and an aliphatic dicarboxylic acid as principal component is particularly desirable due to its high degree of crystallinity. One kind of crystalline polyester may be used, or two or more kinds may be used together. Apart from the crystalline polyester, an amorphous polyester may also be included. The term “principal component” means a content of 50 mass % or more.

Examples of alcohol monomers for obtaining the crystalline polyester include ethylene glycol, diethylene glycol, triethylene glycol, 1,2-propanediol, 1,3-propanediol, dipropylene glycol, trimethylene glycol, tetramethylene glycol, pentamethylene glycol, hexamethylene glycol, octamethylene glycol, nonamethylene glycol, decamethylene glycol, dodecamethylene glycol, neopentyl glycol, 1,4-butadeiene glycol and the like.

Alcohol monomers such as these may be used as principal components in the present invention, but apart from these components, bivalent alcohols such as polyoxyethylenated bisphenol A, polyoxypropylenated bisphenol A and 1,4-cyclohexane dimethanol, aromatic alcohols such as 1,3,5-trihydroxymethylbenzene, and trivalent alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylol ethane and trimethylol propane and the like may also be used.

Examples of carboxylic acid monomers for obtaining the crystalline polyester include oxalic acid, malonic acid, succinic acid, glutaric acid, adipic acid, pimelic acid, suberic acid, glutaconic acid, azelaic acid, sebacic acid, nonanediacarboxylic acid, decanedicarboxylic acid, undecanedicarboxylic acid, dodecanedicarboxylic acid, maleic acid, fumaric acid, mesaconic acid, citraconic acid, itaconic acid, isophthalic acid, terephthalic acid, n-dodecylsuccinic acid, n-dodecenylsuccinic acid, cyclohexanedicarboxylic acid and anhydrides and lower alkyl esters and the like of these acids. Carboxylic acid monomers such as these are used as principal components in the present invention, but apart from these, trivalent and higher polyvalent carboxylic acids may also be used.

Examples of trivalent and higher polyvalent carboxylic acid components include trimellitic acid, 2,5,7-naphthalenetricarboxylic acid, 1,2,4-naphthalenetricarboxylic acid, pyromellitic acid, 1,2,4-butanetricarboxylic acid, 1,2,5-hexanetricarboxylic acid and 1,3-dicarboxyl-2-methyl-2-methylenecarboxypropane, and derivatives of these such as acid anhydrides or lower alkyl esters.

Especially desirable crystalline polyesters include a polyester reaction product of 1,4-cyclohexanedimethanol and adipic acid, a polyester reaction product of tetramethylene glycol, ethylene glycol and adipic acid, a polyester reaction product of hexamethylene glycol and sebacic acid, a polyester reaction product of ethylene glycol and succinic acid, a polyester reaction product of ethylene glycol and sebacic acid, a polyester reaction product of tetramethylene glycol and succinic acid, a polyester reaction product of diethylene glycol and decanedicarboxylic acid, a polyester reaction product of nonamethylene glycol and sebacic acid, a polyester reaction product of decamethylene glycol and sebacic acid, and a polyester reaction product of dodecamethylene glycol and sebacic acid.

The crystalline polyester is preferably a saturated polyester. A saturated polyester is advantageous from the standpoint of the solubility of the crystalline polyester because it does not undergo crosslinking reactions. A preferred crystalline polyester for use in the present invention can be manufactured by ordinary polyester synthesis methods. For example, a decarboxylic acid component and a dialcohol component can be first subjected to an esterification reaction or ester exchange reaction, and then the polycondensation reaction by ordinary methods under reduced pressure or with an introduced flow of nitrogen gas to obtain the crystalline polyester.

An ordinary esterification catalyst or ester exchange catalyst such as sulfuric acid, tert-butyl titanium butoxide, dibutyl tin oxide, manganese acetate or magnesium acetate may be used as necessary during the esterification or ester exchange reaction. Moreover, an ordinary polymerization catalyst such as tert-butyl titanium butoxide, dibutyl tin oxide, tin acetate, zinc acetate, tin disulfide, antimony trioxide, germanium dioxide or another known catalyst may be used for polymerization. The polymerization temperature and amount of the catalyst are not particularly limited, and any may be selected as necessary.

A titanium catalyst is preferred as the catalyst, and a chelate-type titanium catalyst is more preferred. This is because with a crystalline polyester prepared using a titanium catalyst, the titanium or titanium catalyst incorporated into the interior of the polyester during preparation contributes to the charging performance of the toner.

The acid value or hydroxyl value can also be controlled by blocking the terminal carboxyl groups or hydroxyl groups of the crystalline polyester. A monocarboxylic acid or monoalcohol can be used for terminal blocking. Examples of monocarboxylic acids include monocarboxylic acids such as benzoic acid, naphthalenecarboxylic acid, salicylic acid, 4-methylbenzoic acid, 3-methylbenzoic acid, phenoxyacetic acid, biphenylcarboxylic acid, acetic acid, propionic acid, butyric acid, octanoic acid, decanoic acid, dodecanoic acid, and stearic acid. Examples of monoalcohols include methanol, ethanol, propanol, isopropanol, butanol and higher alcohols.

The toner particle preferably contains the crystalline resin in the amount of 3.0 mass parts to 30.0 mass parts, or more preferably 3.0 mass parts to 25.0 mass parts, or still more preferably 3.0 mass parts to 20.0 mass parts per 100 mass parts of the binder resin.

When the content of the crystalline resin is within this range, the aforementioned effects of the invention are greater, and good fixability is obtained. Because moisture absorbency is controlled, moreover, the uniformity of the toner charge is less likely to decline, and increased fogging and the like can be prevented.

The crystalline resin may also be a hybrid resin having amorphous vinyl segments.

One method for manufacturing the hybrid resin is by promoting a polymerization reaction in a pressurized environment when preparing the amorphous vinyl segments. In one specific method, radicals can be generated in a polyester by means of an ester exchange reaction between hydroxyl groups contained in the polyester and an acrylic acid ester or methacrylic acid ester contained in an amorphous vinyl polymer, an esterification reaction between hydroxyl groups in the polyester and carboxyl groups in the amorphous vinyl polymer, an esterification reaction between carboxyl groups in the polyester and hydroxyl groups in the amorphous vinyl polymer, or by a hydrogen abstraction reaction, after which a vinyl monomer can be added and polymerization performed in a pressurized environment. The degree of pressurization in this case is preferably 0.20 MPa to 0.45 MPa.

A monofunctional polymerizable monomer or polyfunctional polymerizable monomer can be used as the polymerizable vinyl monomer used to manufacture the amorphous vinyl segments in the hybrid resin. Examples of monofunctional polymerizable monomers include styrene; styrene derivatives such as a-methylstyrene, o-methylstyrene, m-methylstyrene and p-methylstyrene; polymerizable acrylic monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate and cyclohexyl acrylate; and polymerizable methacrylic monomers having methacrylate substituted in the polymerizable acrylic monomers described above.

Examples of polyfunctional polymerizable monomers include polyfunctional polymerizable acrylic monomers such as diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxy-diethoxy)phenyl)propane, trimethylol propane triacrylate and tetramethylol methane tetracrylate; polyfunctional polymerizable methacrylic monomers having methacrylate substituted in the acrylic polyfunctional polymerizable monomers described above; and divinyl benzene, divinyl naphthalene and divinyl ether.

A monomer having carboxyl or hydroxyl groups or an acrylic acid ester or methacrylic acid ester is preferably included as a vinyl monomer. This is desirable because when carboxyl groups (which are functional groups having strong polarity) are present in the amorphous vinyl segments of the hybrid resin, the amorphous vinyl segments acquire a suitable polarity, and serve to stabilize the toner particle during toner manufacture in an aqueous medium.

It is preferred that the amorphous vinyl segments of the hybrid resin are a copolymer of a polymerizable vinyl monomer and an acrylic acid, because the toner surface is made stronger and more durable by the hydrogen bonds formed by the carboxylic groups of the acrylic acid. The content of the acrylic acid in the hybrid resin is preferably 3.0 mass % or less. Within this range, moisture absorbency is increased in high-temperature, high-humidity environments, and it is possible to suppress a decrease in the triboelectrical charge properties of the toner,

An oil-soluble initiator and/or water-soluble initiator may be used appropriately as the polymerization initiator used to polymerize the polymerizable vinyl monomer when manufacturing the hybrid resin. Examples of oil-soluble initiators include azo compounds such as 2,2′-azobisisobutyronitrile; and peroxides such as t-butyl peroxyneodecanoate, t-hexylperoxypivalate, lauroyl peroxide, t-butylperoxy-2-ethylhexanoate, t-butylperoxyisobutyrate, di-t-butylperoxyisophthalate and di-t-butyl peroxide.

Examples of water-soluble initiators include ammonium persulfate, potassium persulfate, 2,2-azobis(N,N′-dimethyleneisobutyroamidine)hydrochloride, 2,2′-azobis(2-aminodinopropane)hydrochloride, azobis(isobutylamidine)hydrochloride, sodium 2,2′-azobisisobutyronitrilesulfonate, 2,2′-azobis(2-methyl-N-[1,1-bis(hydroxymethyl)2-hydroxyethyl]propionamide), 2,2′-azobis(2-methyl-N-[2-(1-hydroxybutyl)]-propionamide), ferrous sulfate hydrochloride and hydrogen peroxide.

A peroxide is particularly desirable, and when vinyl denaturing a polyester resin by a hydrogen abstraction reaction, a 10-hour half-life temperature of 70° C. to 170° C. or more preferably 75° C. to 130° C. is preferred for achieving suitable reactivity.

The acid value of the crystalline resin is preferably at least 0.1 mg KOH/g or more preferably 5.0 mg KOH/g or less. If the acid value of the crystalline resin is within this range, the crystalline resin can exist in a suitable dispersed state in the binder resin. It is thus possible to obtain the desire plasticization effect on the binder resin, and achieve superior low-temperature fixing performance. This also serves to increase the degree of crystallinity of the crystalline resin, and improve heat resistance. Moreover, controlling the acid value within this range also helps to improve the adhesiveness of the toner with the paper during image formation. When the .toner particle is manufactured by a polymerization method, agglomeration between toner particles tends to be less likely if the acid value of the crystalline resin is 5.0 mg KOH/g or less. This is desirable for improving the charge stability and long-term stability.

The acid value of the crystalline resin can be controlled by controlling the ratio of the alcohol component and acid component making up the crystalline resin, by controlling the types of monomers, and by terminal group treatment of the crystalline resin.

The weight-average molecular weight (Mw) of the crystalline resin is preferably 10,000 to 80,000, or more preferably 13,000 to 40,000. If the Mw is 10,000 to 80,000, the degree of crystallinity of the crystalline resin can be maintained at a high level in the toner manufacturing process, and the plasticization effect of the crystalline resin can be obtained rapidly in the fixing process. It is thus possible to achieve both excellent heat-resistant storability and superior fixability under low-temperature conditions and high-speed conditions.

The weight-average molecular weight (Mw) of the crystalline resin can be controlled by adjusting the various conditions for manufacturing the crystalline resin, such as the material ratios of the polyvalent carboxylic acid and diol raw materials, the reaction temperature, reaction time and the like.

### [Binder Resin]

An amorphous resin commonly used as a binder resin in toners can be used as the binder resin. Specifically, a styrene-acrylic resin (styrene-acrylic acid ester copolymer, styrene-methacrylic acid ester copolymer, etc.), polyester, epoxy resin, styrene-butadiene copolymer or the like can be used.

### [Colorant]

The toner of the invention contains a colorant. Examples of colorants include black colorants, yellow colorants, magenta colorants, cyan colorants and the like.

Examples of black colorants include carbon black, magnetic materials, and black colorants obtained by color matching the yellow, magenta and cyan colorants shown below.

Examples of yellow colorants include monoazo compounds, disazo compounds, condensed azo compounds, isoindolinone compounds, anthraquinone compounds, azo metal complexes, methine compounds, arylamide compounds and the like. Specific examples include the following: C. I. Pigment Yellow 12, 13, 14, 15, 17, 62, 73, 74, 83, 93, 94, 95, 97, 109, 110, 111, 120, 128, 129, 138, 147, 150, 151, 154, 155, 168, 180, 185 and 214, and C. I. Solvent Yellow 93, 162 and the like.

Examples of magenta colorants include monoazo compounds, condensed azo compounds, diketo-pyrrolo-pyrrole compounds, anthraquinone compounds, quinacridone compounds, basic dye lake compounds, naphthol compounds, benzimidazolone compounds, thioindigo compounds and perylene compounds, Specific examples include C. I. Pigment Red 2, 3, 5, 6, 7, 23, 48:2, 48:3, 48:4, 57:1, 81:1, 122, 146, 150, 166, 169, 177, 184, 185, 202, 206, 220, 221, 238, 254 and 269, and C. I. Pigment Violet 19 and the like.

Examples of cyan colorants include copper phthalocyanine compounds and their derivatives, anthraquinone compounds, basic dye lake compounds and the like. Specific examples include C. I. Pigment Blue 1, 7, 15, 15:1, 15:2, 15:3, 15:4, 60, 62, 66 and the like.

These colorants may be used singly, or as a mixture, or in the form of a solid solution. The colorant is selected out of considerations of hue angle, chroma, lightness, light resistance, OHP transparency and dispersibility in the toner. The added amount of the colorant is preferably 1 mass part to 20 mass parts per 100 mass parts of the binder resin.

A magnetic material may also be included as a colorant. Examples of magnetic materials include the following: iron oxides such as magnetite, hematite and ferrite; metals such as iron, cobalt and nickel, alloys of these metals with metals such as aluminum, cobalt, copper, lead, magnesium, tin, zinc, antimony, beryllium, bismuth, cadmium, calcium, magnesium, selenium, titanium, tungsten and vanadium, and mixtures of these and the like.

The magnetic material is preferably one that has been surface modified, and more preferably one that has been hydrophobically treated with a surface modifier that is a substance that does not inhibit polymerization. Examples of such surface modifiers include silane coupling agents and titanium coupling agents.

The number-average particle diameter of these magnetic materials is preferably 2 μm or less, or more preferably 0.1 μm to 0.5 μm. The content is preferably 20 mass parts to 200 mass parts or more preferably 40 mass parts to 150 mass parts per 100 mass parts of the binder resin.

### [Charge Control Agent]

The toner particle may also contain a charge control agent. A conventional known charge control agent may be used as the charge control agent in the toner particle, without any particular limitations. Specific examples include negative charge control agents including metal compounds of aromatic carboxylic acids such as salicylic acid, alkylsalicylic acid, dialkylsalicylic acid, naphthoic, acid and dicarboxylic acid; metal salts or metal complexes of azo dyes or azo pigments; and boron compounds, silicon compounds, calixarene, and polymers or copolymers containing sulfonic acid groups, sulfonate groups or sulfonic acid ester groups (hereunder sometimes called polymers having sulfonic acid groups) and the like. Examples of positive charge control agents include quaternary ammonium salts and polymeric compounds having quaternary ammonium salts in the side chains; guanidine compounds; nigrosine compounds; and imidazole compounds and the like.

Examples of monomers for manufacturing polymers having sulfonic acid groups include styrenesulfonic acid, 2-acrylamido-2-methylpropanesulfonic acid, 2-methacrylamido-2-methylpropanesulfonic acid, vinylsulfonic acid, methacrylsulfonic acid and the like. A polymer containing sulfonic acid groups that is used in the present invention may be a homopolymer of the one monomer, or a copolymer of this monomer with another monomer. Examples of monomers that form copolymers with these monomers include the vinyl monomers listed as polymerizable monomers for forming the binder resin.

The used amount of these charge control agents is not strictly limited because it depends on the type of binder resin, the presence or absence of other additives, and the toner manufacturing methods including dispersion methods. In the case of internal addition, the amount is preferably 0.1 mass parts to 10 mass parts, or more preferably 0.1 mass parts to 5 mass parts, or still more preferably 0.1 mass parts to 3 mass parts per 100.0 mass parts of the binder resin. In the case of external addition, it is preferably 0.005 mass parts to 1.0 mass parts or more preferably 0.01 mass parts to 0.3 mass parts per 100.0 mass parts of the toner particle.

### [Release Agent]

A release agent may also be included in the toner particle. A known release agent may be used, without any particular limitations.

Examples include the following compounds: aliphatic hydrocarbon waxes such as low-molecular-weight polyethylene, low-molecular-weight polypropylene, microcrystalline wax, paraffin wax and Fischer-Tropsch wax; oxides of aliphatic hydrocarbon waxes, such as polyethylene oxide wax, or block copolymers of these; waxes containing fatty acid esters as principal component such as carnauba wax, sasol wax, ester wax and montanic acid ester wax; partly or completely deacidified fatty acid esters such as deacidified carnauba wax; waxes obtained by grafting vinyl monomers such as styrene and acrylic acid to aliphatic hydrocarbon waxes; partial esters of fatty acids and polyvalent alcohols such as behenic acid monoglycerides; and methyl ester compounds with hydroxyl groups, obtained by hydrogenation or the like of plant-based oils and fats.

The content of the release agent is preferably 1.0 mass parts to 40.0 mass parts or more preferably 3.0 mass parts to 25.0 mass parts per 100.0 mass parts of the binder resin.

### [External Additives]

The toner of the present invention may contain an inorganic fine particle in addition to a toner particle containing at least a binder resin and a colorant. The inorganic fine particle is preferably added externally. For example, the toner of the invention can be obtained by externally adding and mixing the inorganic fine particle, thereby attaching it to the surface of the toner particle. A known method may be adopted as the method of externally adding the inorganic fine particle. One example is a method of mixing using a Henschel mixer (Mitsui Miike Chemical Engineering Machinery, Co., Ltd.). The added amount of the inorganic fine particle is preferably 0.01 mass parts to 5.0 mass parts, or more preferably 0.1 mass parts to 4.0 mass parts per 100 mass parts of the toner particle. If the added amount is within this range, it is possible to control a loss of fixability while obtaining sufficient improvement in flowability. The number-average particle diameter of the primary particles of this inorganic fine particle is preferably 4 nm to 80 nm, or more preferably 4 nm to 60 nm.

Examples of inorganic fine particles include metal oxide particles such as titanium oxide particles, aluminum oxide particles, and zinc oxide particles; and silica fine particles such as wet silica fine particles and dry silica fine particles. A silica fine particle is preferred in the present invention. These metal oxide or silica fine particles may also be surface treated with a treatment agent such as a silane coupling agent, titanium coupling agent, silicone oil or the like. Other examples include aluminum-doped silica, strontium titanate and hydrotalcite. Other external additives that can be added include fluorine resin particles such as vinylidene fluoride fine particles or polytetrafluoroethylene fine particles; and fatty acid metal salts such as zinc stearate, calcium stearate, lead stearate and the like.

### [Manufacturing Method]

The toner of the present invention may be manufactured by any method as long as it conforms to the desired specifications, but preferably it contains a toner particle manufactured by suspension polymerization.

Suspension polymerization is a manufacturing method comprising a suspension step in which a polymerizable monomer composition containing a polymerizable monomer, a colorant and a crystalline resin as well as a polar resin and other additives as necessary is added to an aqueous medium to form particles of the polymerizable monomer composition in the aqueous medium, and a polymerization step in which the polymerizable monomer contained in the particles of the polymerizable monomer composition is polymerized with a polymerization initiator.

The polymerization initiator may be added at the same time when other additives are added to the polymerizable monomer, or may be mixed in immediately before suspension in the aqueous medium. The polymerization initiator may also be dissolved in the polymerizable monomer or in a solvent and added immediately after granulation and before the beginning of the polymerization reaction.

Using this method, it is easy to form a so-called “core-shell structure” in which the crystalline resin and low-Tg binder resin are located in the center of the toner, and the high-Tg polar resin is located on the surface of the toner particle due to differences in the polarity of the materials. With a toner particle having such a structure, the heat resistance and durability of the toner can be improved while maintaining good low-temperature fixability. The circularity of the toner particle also increases, and the developing properties and transfer properties are further improved.

With this manufacturing method, moreover, the crystalline resin is dissolved in the polymerizable monomer composition under the heating conditions. The composition is then maintained in the same heated state while being granulated via a suspension process, and the polymerization initiator is added to promote a polymerization reaction and manufacture a toner particle. Because the polymerization reaction is performed with the crystalline resin in a melted state from the beginning of polymerization, phase separation of the crystalline resin is avoided as much as possible until the end of polymerization, and it is possible to manufacture a toner particle while maintaining the crystalline polyester in a finely dispersed state in the binder resin.

Methods such as pulverization methods in which the toner composition is melt compounded and then simply pulverized face major technical hurdles in terms of controlling the structure of the toner particle. On the other hand, in methods such as emulsion aggregation methods in which a liquid dispersion of fine particles such as a resin particle dispersion is aggregated in an aqueous medium to obtain aggregate particles that are then fused to obtain an electrophotographic toner, imbalances are likely to occur in the internal structure of the toner particles, affecting the dispersed state of each particle.

An aqueous medium here is a medium consisting primarily of water. Specifically, it may be water itself, water with a small amount of a surfactant added, water with a pH adjuster added, or water with an organic solvent added.

The polymerizable monomer contained in the polymerizable monomer composition is a component that will constitute the binder resin when it is polymerized. A vinyl monomer capable of radical polymerization can be used as the polymerizable monomer in the present invention. A monofunctional vinyl monomer or polyfunctional vinyl monomer may be used as this vinyl monomer.

Examples of monofunctional vinyl monomers include the following: styrene; polymerizable styrene monomers such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene; polymerizable acrylic monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethylphosphate ethyl acrylate, diethylphosphate ethyl acrylate, dibutylphosphate ethyl acrylate and 2-benzoyloxyethyl acrylate; polymerizable methacrylic monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethylphosphate ethyl methacrylate and dibutylphosphate ethyl methacrylate; methylene aliphatic monocarboxylic acid esters; vinyl esters such as vinyl acetate, vinyl propionate, vinyl butyrate, vinyl benzoate and vinyl formate; vinyl ethers such as vinyl methyl ether, vinyl ethyl ether and vinyl isobutyl ether; and vinyl ketones such as vinyl methyl ketone, vinyl hexyl ketone and vinyl isopropyl ketone.

Polyfunctional vinyl monomers include the following: diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxy-diethoxy)phenyl)propane, trimethylol propane triacrylate, tetramethylol methane tetracrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxy-diethoxy)phenyl)propane, 2,2′-bis(4-(methacryloxy-polyethoxy)phenyl)propane, trimethylol propane trimethacrylate, tetramethylol methane tetramethacrylate, divinyl benzene, divinyl naphthalene and divinyl ether.

The aforementioned monofunctional vinyl monomers may be used alone, or two or more may be combined, or a monofunction vinyl monomer may be used in combination with a polyfunctional vinyl monomer.

A polyfunctional vinyl monomer may also function as a crosslinking agent. The crosslinking agent may be used in the amount of normally 0.001 mass parts to 15 mass parts per 100 mass parts of the monofunctional vinyl monomer. In addition to those listed above, examples of this polyfunctional vinyl monomer include divinyl compounds such as divinylaniline, divinylsulfide and divinylsulfone, and compounds having three or more vinyl groups.

An oil-soluble initiator and/or a water-soluble initiator may be used as the polymerization initiator. The half-life at the reaction temperature during the polymerization reaction is preferably 0.5 hours to 30 hours. When the polymerization reaction is performed with an added amount of 0.5 mass parts to 20 mass parts per 100 mass parts of the polymerizable monomer, normally a polymer with a maximal molecular weight in the range of 10,000 to 40,000 is obtained, resulting in a toner with a suitable strength and fusion characteristics.

Examples of polymerization initiators include the following: azo- and diazo-based polymerization initiators such as 2,2′-azobis-(2,4-dimethylvaleronitrile), 2,2′-azobisisobutyronitrile, 1,1′-azobis (cyclohexane-1-carbonitrile), 2,2′-azobis-4-methoxy-2,4-dimethylvaleronitrile and azobisisobutyronitrile; and peroxide polymerization initiators such as benzoyl peroxide, t-butylperoxy-2-ethylhexanoate, t-butylperoxypivalate, t-butylperoxyisobutyrate, t-butylperoxyneodecanoate, methylethylketone peroxide, diisopropyl peroxicarbonate, cumene hydroperoxide, 2,4-dichlorobenzoyl peroxide and lauroyl peroxide. Preferred is a polymerization initiator that generates an ether compound during decomposition in the polymerization reaction.

An inorganic or organic dispersion stabilizer can be added to the aqueous medium. Examples include calcium phosphate salts, magnesium phosphate, aluminum phosphate, zinc phosphate, calcium carbonate, magnesium carbonate, calcium hydroxide, magnesium hydroxide, aluminum hydroxide, calcium metasilicate, calcium sulfate, barium sulfate, bentonite, silicon oxide and aluminum oxide. Of these, it is especially desirable to use a calcium phosphate salt. Desirable examples of .calcium phosphate salts include hydroxyapatite, fluoroapatite, calcium-deficient apatite, carbonate apatite, tricalcium phosphate, calcium hydrogen phosphate, calcium dihydrogen phosphate, calcium diphosphate, tetracalcium phosphate, octacalcium phosphate and mixtures of more than one of these. Considering the positive charging properties of these calcium phosphate salts and their solubility in acids and the like, hydroxyapaptite is preferably included in the calcium phosphate salts used in the present invention.

Examples of organic dispersion stabilizers include polyvinyl alcohol, gelatin, methyl cellulose, methyl hydroxypropyl cellulose, ethyl cellulose, carboxymethyl cellulose sodium salts, polyacrylic acid and salts thereof, and starch and the like.

The dispersion stabilizer is preferably used in the amount of 0.2 mass parts to 20.0 mass parts per 100.0 mass parts of the polymerizable monomer.

A surfactant may be used to finely disperse, these dispersion stabilizers. This promotes the-desired effect of the dispersion stabilizer. The type of surfactant is not particularly limited. Examples include dodecyl benzene sodium sulfate, sodium tetradecyl sulfate, sodium pentadecyl sulfate, sodium octyl sulfate, sodium oleate, sodium laurate, potassium stearate, calcium oleate and the like.

When an inorganic compound is used as the dispersion stabilizer, a commercial compound may be used as is, but the organic compound may also be produced and used in the aqueous medium in order to obtain finer particles.

In the case of calcium phosphates such as hydroxyapatite and calcium triphosphate, for example, a phosphate salt aqueous solution and a calcium salt aqueous solution can be mixed with strong agitation.

In the present invention, a known chain transfer agent or polymerization inhibitor may be used to control the degree of polymerization of the polymerizable monomer.

The methods of measuring the physical property values of the present invention are explained below.

### (1) Measuring Viscoelasticity of Toner

ARES™ (TA Instruments) was used as the measurement device,

For measurement purposes, a torsion rectangular fixture was installed and cooled to 20° C., and Zero Gap was selected. A pressure-molded measurement sample was then fixed on the torsion rectangular fixture, and held so that the normal force was 50 g to 100 g. Measurement was initiated after it had been confirmed that the measurement sample was undamaged and was fixed on the fixture. It is important to set the sample so that the initial normal force is −50 g, and so that the measurement sample is firmly fixed to the measurement fixture.

The samples can be cooled to −50° C. by attaching the ARES unit to an air dryer (AI-220D, Airtek) for drying the compressed air used for temperature regulation in the ARES unit and a chiller (PGC-150, Polycold International) for cooling the compressed air.

Sample preparation and measurement were performed under the following conditions.

Measurement fixture: Torsion rectangular fixture

Measurement sample: dried for 24 hours with a 20° C. vacuum drier prior to measurement

Sample shape: Long side 30.0 mm, short side 12.7 mm, thickness 2.0 mm to 3.0 mm, uniformity of width ±0.05 mm

Sample molding conditions: 25° C., 20 MPa, pressure time 5 minutes in a tablet molder

Angular vibrational frequency: 6.28 rad/s

Ramp rate: 2.0° C./min from 20° C. to 120° C.

Initial applied strain: 0.02%, measurement performed in Auto Strain mode

The conditions in Auto Strain mode are shown below.

Max Applied Strain set at 20.0%.

Max Allowed Torque set at 150.0 g·cm.

Min Allowed Torque set at 0.5 g·cm.

Strain Adjustment set to 20.0% of Current Strain.

After measurement, the temperature (° C.) was plotted on the abscissa and the common logarithm (LogG″) of a value obtained by dividing the loss elastic modulus G″ of the toner by the loss elastic modulus unit (Pa) on the ordinate to obtain a temperature-loss elastic modulus curve.

### (2) Weight-Average Molecular Weight of Toner

The weight-average molecular weight (Mw) of the toner can be measured as follows by gel permeation chromatography (GPC).

First, the toner is dissolved in tetrahydrofuran (THF) at room temperature over the course of 24 hours. The resulting solution-is then filtered with a 0.2 μm pore diameter solvent-resistant membrane filter (Maishori Disk, Tosoh Corporation) to obtain a sample solution. The concentration of THF-soluble components was adjusted to 0.8 mass % in the sample solution. The following measurements are performed using this sample solution.

Unit: HLC8120 GPC (Detector: RI) (Tosoh Corporation)

Columns: Shodex KF-801, 802, 803, 804, 805, 806, 807 (7 columns, Showa Denko K.K.)

Eluent: Tetrahydrofuran (THF)

Flow rate: 1.0 ml/min

Oven temperature: 40.0° C.

Sample injection volume: 0.10 ml

A molecular weight calibration curve prepared using standard polystyrene resin (for example, TSK™ Standard Polystyrene F-850, F-450, F-288, F-128, F-80, F-40, F-20, F-10, F-4, F-2, F-1, A-5000, A-2500, A-1000, A-500, Tosoh Corporation) was used for calculating the molecular weight of the samples.

### (3) Weight-Average Molecular Weight of Crystalline Resin

The weight-average molecular weight of the crystalline resin is measured as follows by gel permeation chromatography (GPC).

First, 0.03 g of crystalline-resin is dispersed in 10 ml of o-dichlorobenzene, and dissolved by still standing for 24 hours at 135° C. The resulting solution is then filtered with a 0.2 μm pore diameter solvent-resistant membrane filter (Maishori Disk, Tosoh Corporation) to obtain a sample solution. Measurement is performed under the following conditions using this sample solution.

### [Analysis Conditions]

Separation column: Shodex (TSK GMHHR-H HT20)×2

Column temperature: 135° C.

Mobile phase solvent: o-dichlorobenzene

Mobile phase flow rate: 1.0 ml/min

Sample concentration: about 0.3%

Injection volume: 300 μl

Detector: Shodex RI-71 differential refractometer detector

A molecular weight calibration curve prepared using standard polystyrene resin (for example, TSK™ Standard Polystyrene F-850, F-450, F-288, F-128, F-80, F-40, F-20, F-10, F-4, F-2, F-1, A-5000, A-2500, A-1000, A-500, Tosoh Corporation) was used for calculating the molecular weight of the samples.

### (4) Glass Transition Temperature Tg of Toner, Melting Point Tm (C) of Crystalline Resin, and Heat Adsorption of Crystalline Resin

The glass transition temperature Tg of the toner and the melting point of the crystalline resin were measured in accordance with ASTM D3418-82 using a Q1000 differential scanning calorimeter (TA Instruments).

Temperature correction of the detection part was performed using the melting points of indium and zinc, while the heat quantity was corrected using the fusion heat of indium.

Specifically, 5 mg of toner or 1 mg of crystalline resin was weighed exactly and placed in an aluminum pan, and modulation measurement was performed within a measurement range of 20° C. to 140° C. at a ramp rate of 1° C./min with an amplitude temperature width of ±0.318° C./min using an empty aluminum pan for reference. Specific heat changes are obtained within the temperature range of 20° C. to 140° C. in this temperature rise process. The glass transition temperature Tg is the point of intersection between the differential thermal curve and a straight line drawn between the center of the baseline before the specific heat changes in the reversing heat flow curve and the center of the baseline after the specific heat changes. The melting point Tm (C) is the peak temperature of the endothermic main peak in the reversing heat flow. The presence or absence of crystal segments in the crystalline resin of the present invention is determined based on the presence or absence of an endothermic main peak in the specific heat change curve.

The heat absorption of the crystalline resin is obtained by determining the area A of a region enclosed by the endothermic main peak and a straight line drawn between the point at which the endothermic main peak diverges from the extrapolated extension of the baseline before appearance of the endothermic main peak and the point of contact between the endothermic main peak and the extrapolated extension of the baseline after completion of the endothermic main peak. When two or more such enclosed regions exist independently, the total of these is given as the heat absorption.

The area B of the endothermic peak of the crystalline resin at 50° C. or less is the area of the region at 50° C. or less out of the area values described above.

Consequently, the ratio (%) of the endothermic peak area at 50° C. or less relative to the peak area of the endothermic main peak is calculated from (B/A×100).

### (5) Acid Value of Crystalline Resin

The acid value of the crystalline resin is calculated as follows.

The acid value is the number of mg of potassium hydroxide needed to neutralize the acid contained in 1 g of sample. The acid values of the crystalline resin and polar resin are measured in accordance with JIS K 0070-1992, and specifically the following procedures are followed.

### (a) Preparation of Sample

1.0 g of phenolphthalein is dissolved in 90 ml of ethyl alcohol (95 vol %), and ion-exchange water is added to a total of 100 ml to obtain a phenolphthalein solution.

7 g of special-grade potassium hydroxide is dissolved in 5 ml of water, and ethyl alcohol (95 vol %) is added to a total of 1 L. This is placed in an alkali resistant container and left for 3 days while avoiding contact with carbon dioxide and the like, and then filtered to obtain a potassium hydroxide solution. The obtained potassium hydroxide solution is stored in an alkali resistant container. The factor of the potassium hydroxide solution is determined from the amount of potassium hydroxide solution required for neutralization, which is measured by placing 25 ml of 0.1 mol/l hydrochloric acid in a triangular flask, adding several drops of the phenolphthalein solution, and titrating this with the potassium hydroxide solution. The 0.1 mol/l hydrochloric acid is prepared in accordance with JIS K 8001-1998.

### (b) Operations

### (i) Main Test

2.0 g of pulverized crystalline resin sample is weighed into a 200 ml triangular flask, 100 ml of a toluene/ethanol (2:1) mixed solution is added, and the sample is dissolved over the course of 5 hours. Several drops of the previous phenolphthalein solution are then added as an indicator, and this is then titrated with the potassium hydroxide solution. Titration is considered to be complete when the light pink color of the indicator persists for 30 seconds.

### (ii) Blank Test

Titration is performed by the same operations but without a sample (using only a mixed toluene/ethanol (2:1) solution).

(c) The test results are entered into the following formula to calculate the acid value.

A=[(C−B)×f×5.61]/S

In the formula, A is the acid value (mg KOH/g), B is the added amount (ml) of the potassium hydroxide solution in the blank test, C is the added amount (ml) of the potassium hydroxide solution in the main test, f is the factor of the potassium hydroxide solution, and S is the sample (g).

### (6) Weight-Average Particle Diameter (D4) and Number-Average Particle Diameter (D1)

The weight-average particle diameter (D4) and number-average particle diameter (D1) were measured with 25,000 effective measurement channels using a precision particle size distribution measurement device (Coulter Counter Multisizer® 3, Beckman Coulter, Inc.) based on the pore electrical resistance method and equipped with a 100 μm aperture tube, together with the accessory dedicated software (Coulter Counter Multisizer 3 Version 3.51, Beckman Coulter, Inc.) for setting measurement conditions and analyzing the measurement data, and the measurement data were analyzed and the diameters calculated. The aqueous electrolytic solution used for measurement may be a solution of high purity sodium chloride dissolved in ion-exchange water to a concentration of about 1 mass %, such as Isoton II (Beckman Coulter, Inc.).

The dedicated software settings were performed as following prior to measurement and analyses.

On the “Change standard operating method (SOM)” screen of the dedicated software, the total count number of the control mode is set at 50,000 particles, the number of measurements is set at 1, and the Kd value is set at a value obtained using “standard particle 10.0 μm” (Beckman Coulter, Inc.). A threshold/noise level measurement button is pressed to automatically set the threshold and noise level. The current is set at 1,600 μA, the gain is set at 2, and the electrolyte solution is set at the ISOTON II. Flush of the aperture tube after measurement is checked.

On the “Conversion Setting from Pulse to Particle Diameter” screen of the dedicated software, the bin interval is set at the logarithmic particle diameter, the particle diameter bin is set at the 256 particle diameter bin, and the range of the particle diameter is set at 2 μm to 60 μm.

The specific measurement methods are as follows.

(a) About 200 ml of the aqueous electrolytic solution is placed in a 250 ml glass round-bottomed beaker dedicated to the Multisizer 3, set on a sample stand, and stirred with a stirrer rod counterclockwise at a rate of 24 rotations/second. Contamination and bubbles in the aperture tube are removed by means of the “Aperture flush” function of the analytical software.

(b) Approximately 30 ml of the aqueous electrolytic solution is placed in a 100 ml glass flat-bottom beaker and approximately 0.3 ml of a diluted solution of “CONTAMINON N” (a 10 mass % aqueous solution of a pH 7 neutral detergent for washing precision measurement equipment, comprising a nonionic surfactant, an anionic surfactant and an organic builder, made by Wako Pure Chemical Industries, Ltd.) diluted 3 times by mass with ion-exchange water is added thereto as a dispersant.

(c) A predetermined amount of ion-exchange water is placed in a water bath of an ultrasonic disperser “Ultrasonic Dispersion System Tetora 150” (made by Nikkaki Bios Co., Ltd.) with an electric output of 120 W, in which two oscillators with an oscillation frequency of 50 kHz are built-in with the phases of the oscillators shifted by 180° to one other. About 2 ml of the CONTAMINON N is added to the water bath.

(d) The beaker of (b) is set in a beaker fixing hole of the ultrasonic disperser, and the ultrasonic disperser is operated. The height position of the beaker is adjusted so as to maximize the resonance state of the surface of the aqueous electrolytic solution in the beaker.

(e) With the aqueous electrolytic solution in the beaker of (d) exposed to ultrasound waves, approximately 10 mg of the toner is added to the aqueous electrolytic solution little by little, and dispersed. Further, the ultrasonic dispersion is continued for 60 seconds. In the ultrasonic dispersion, the temperature of the water in the water bath is properly adjusted so as to-be not less than 10° C. and not more than 40° C.

(f) Using a pipette, the aqueous electrolytic solution of (e) with the sample dispersed therein is added dropwise to the round-bottom beaker of (a) disposed on the sample stand, and the measurement concentration is adjusted so as to be approximately 5%. Measurement is then performed until the number of measured particles reaches 50,000.

(g) The measurement data is analyzed with the dedicated software attached to the apparatus, and the weight-average particle diameter (D4) and number-average particle diameter (D1) are calculated. The weight-average particle diameter (D4) is the “average diameter” on the analysis/volume statistical value (arithmetic average) screen when graph/vol % is set by the dedicated software, and the number-average diameter (D1) is the “average diameter” on the analysis/number statistical value (arithmetic average) screen when graph/number % is set by the dedicated software.

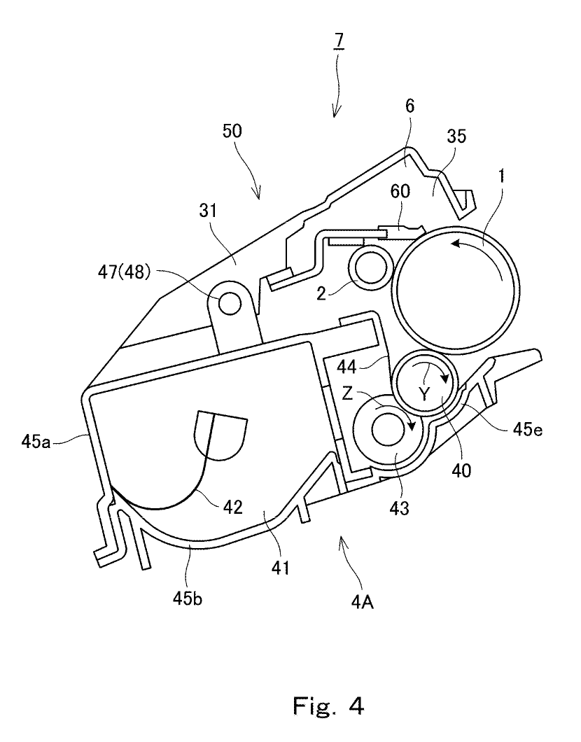

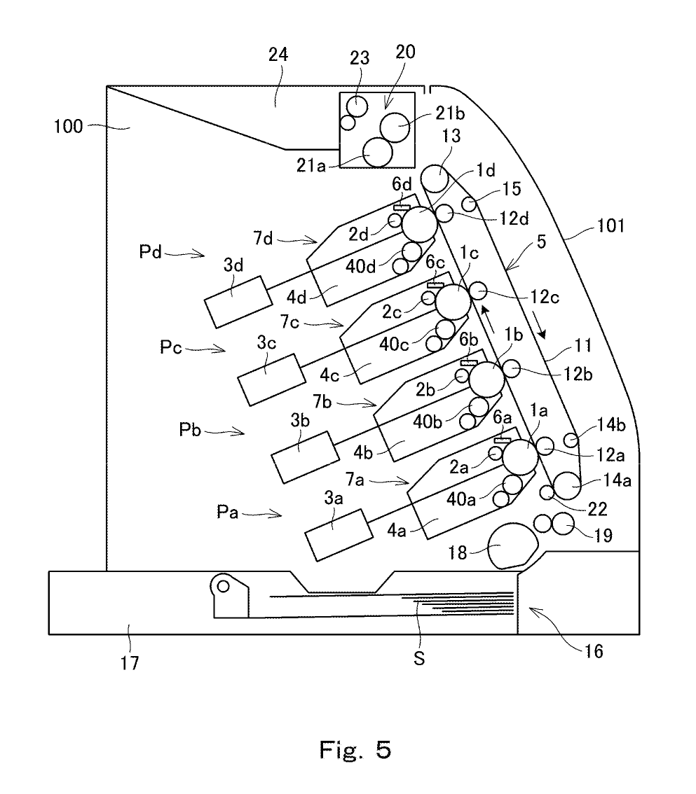

Examples of image-forming methods using the toner of the invention are explained next using FIGS. 4 and 5. However, the present invention is not limited to these.

### (Process Cartridge)

FIG. 4 is a cross-sectional view of a process cartridge 7 (hereunder sometimes called a “cartridge”), which can be used favorably in an image-forming apparatus using the toner of the invention.

Cartridge 7 has a photoreceptor drum 1, a cleaner unit 50 provided with a charging means 2 and a cleaning means 6, and a developing unit 4A having a developing means 4 for developing electrostatic latent images formed on the photoreceptor drum 1. The photoreceptor 1 is attached rotatably via an axle-bearing member to a cleaning frame 31 of the cleaner unit 50.

Photoreceptor drum 1 is in contact with a charging roller 2 for uniformly charging a photoreceptive layer provided on the outer cylindrical surface of the photoreceptor drum 1, and with a cleaning blade 60 for removing developer (residual toner) remaining on the photoreceptor drum 1 after transfer. The toner (removed toner) removed from the surface of the photoreceptor drum 1 by the cleaning blade 60 is held in a removed toner holding chamber 35 provided on the cleaning frame 31.

Developing unit 4A has developing frames 45 (45a, 45b, 45e) for holding toner, and a developing roller 40 (which rotates in the direction of arrow Y) is supported rotatably on a developing frame 45, via an axle-bearing member. A toner supply roller 43 (which rotates in the direction of arrow Z) and a toner regulating member 44 are provided in contact with the developing roller 40. A toner transport mechanism 42 is also provided to agitate the toner held in the developing frame 45 and transport it to the toner supply roller 43.

The developing unit 4A is supported swingably on the cleaning unit 50. That is, connecting holes 47 and 48 provided at both ends of the developing frame 45 are lined up with supporting holes (not shown) provided at both ends of the cleaning frame 31 of the cleaner unit 50, and pins (not shown) are inserted from both ends of the cleaner unit 50.

Moreover, a pressure spring (not shown) exerts a constant force on the developing unit 4A as the supporting holes being the rotational axis so as to maintain contact between the developing roller 40 and the developing drum 1.

During development, the toner contained in a toner container 41 is transported to the toner supply roller 43 by the toner agitation mechanism 42. The toner supply roller 43 supplies toner to the developing roller 40 by sliding against the developing roller 40, causing the toner to adhere to the developing roller 40. As the developing roller 40 rotates, the toner adhering to the developing roller 40 reaches the toner regulating member 44. The toner regulating member 44 regulates the toner to form the specified thin toner layer and contribute the desired charge quantity. As the developing roller 40 continues to rotate, the toner that has formed a thin layer on the developing roller 40 is transported to the developing area, where the developing roller 40 approaches the photoreceptor drum 1. In the developing area, this attaches to an electrostatic latent image formed on the surface of the photoreceptor drum 1 by a developing bias applied to the developing roller 40 from a power source (not shown), developing the latent image. Toner remaining on the surface of the developing roller 40 without contributing to the development of the electrostatic latent image is returned to the developing frame 45 as the developing roller 40 rotates. It is then detached from the developing roller 40 at the area of contact with toner supply roller 43, and collected. The collected toner is then agitated and mixed with the remaining toner by the toner agitation mechanism 42.

A method can be adopted using an elastic roller as the developing roller 40, and bringing it into contact with the surface of the photoreceptor drum 1. In developing systems in general in which a toner support body is brought into contact with a photoreceptor, the toner is likely to be damaged or deformed, but such changes can be effectively suppressed using the toner of the present invention.

### (Image-Forming Apparatus)

FIG. 5 is a cross-sectional view of one example of an image-forming apparatus. An image-forming apparatus 100 has four image-forming stations Pa, Pb, Pc and Pd arrayed vertically. Process cartridges 7 (7a, 7b, 7c, 7d) are mounted detachably by a mounting mechanism (not shown) onto the image-forming stations Pa, Pb, Pc and Pd, respectively. The magenta, cyan, yellow and black cartridges 7a, 7b, 7c and 7d all have the same configuration.

In this view, image-forming stations Pa, Pb, Pc and Pd are arrayed at a slight angle in the vertical direction, but they may also be aligned in the exact vertical direction without being angled. The process cartridges 7 may be the same as those shown in FIG. 4, or may be different.

Each cartridge 7 (7a, 7b, 7c, 7d) is provided with a photoreceptor drum 1 (1a, 1b, 1c, 1d). The photoreceptor drums 1 are rotated counter-clockwise in the drawing by a drive mechanism (not shown). The following mechanisms are provided in order in the direction of rotation around each photoreceptor drum 1: (A) charging means 2 (2a, 2b, 2c, 2d) for uniformly charging the surface of each photoreceptor drum 1; (B) scanner units 3 (3a, 3b, 3c, 3d) for forming electrostatic latent images on each photoreceptor drum 1 by exposing it to a laser beam based on image data; (C) developing means 4 (4a, 4b, 4c, 4d) for attaching a developer (hereunder called a toner) to the electrostatic latent images to develop toner images; (D) a transfer unit 5 for transferring the toner image on each photoreceptor drum 1 to a recording medium S; and cleaning means 6 (6a, 6b, 6c, 6d) for removing toner remaining on the surfaces of photoreceptor drums 1 after transfer.

Each cartridge 7 is made up of a photoreceptor drum 1 and a charging means 2, developing means 4 and cleaning means 6 as process mechanisms, all contained together as a unit in a cartridge frame to form a cartridge.

The photoreceptor drums 1 (1a, 1b, 1c, 1d) are composed with a photoreceptive layer disposed on the outer surface of a cylinder. Both ends of each photoreceptor drum 1 are supported rotatably by a support member. The drive force from a drive motor (not shown) at one of these ends is transmitted to rotate the drum counter-clockwise.

A photoreceptor drum having a photoconductive insulating material layer of a-Se, CdS, ZnO₂, OPC, a-Si or the like can be used favorably as the photoreceptor. The binder resin of the organic photoreceptive layer in the OPC photoreceptor is not particularly limited. A polycarbonate resin, polyester resin or acrylic resin is particularly desirable because it has excellent transfer properties and resists melt adhesion of the toner to the photoreceptor and filming by additives.

A contact charging system is used for the charging means 2 (2a, 2b, 2c, 2d). The charging means 2 are conductive rollers formed in roller shape. These rollers are brought into contact with the photoreceptor drums 1 as charging bias voltage is applied to the rollers. The surface of the photoreceptor drums 1 is uniformly charged in this way.

The scanner units 3 (3a, 3b, 3c, 3d) use laser diodes (not shown) to expose the surface of each charged photoreceptor drum 1 to image light corresponding to an image signal via high-speed rotating polygon mirrors (not shown) and imaging lenses in response to image data. An electrostatic latent image is formed in this way on the photoreceptor drum.

The developing means 4 (4a, 4b, 4c, 4d) comprise toner containers 41 filled with magenta, cyan, yellow and black toner, respectively. The toner in each toner container 41 is sent to a toner supply roller 43 by a toner feed mechanism 42.

The toner supply roller 43 rotates in the clockwise direction in the figure, acting as a toner support to supply toner to the developing roller 40, and also detaches residual toner that remains on the developing roller 40 without contributing to development of the electrostatic latent image.

The toner supplied to the developing roller 40 is spread on the outer cylindrical surface of the developing roller 40 (which rotates clockwise) by the toner regulating means 44, which is pressed against the outer cylindrical surface of developing roller 40, and charge, is applied. Developing bias is then applied to the photoreceptor drum 1 with the formed latent image and to the facing developing roller 40. The toner on the photoreceptor drum 1 is thus developed in response to the latent image.

The transfer unit 5 faces all of the photoreceptor drums 1 (1a, 1b, 1c, 1d), and comprises an electrostatic transfer belt 11 that cycles in contact with the drums. This transfer belt 11 extends around a drive roller 13, driven rollers 14a and 14b, and tension roller 15, and electrostatically adsorbs recording medium S onto its outer surface on the left in the figure. The transfer belt 11 then circulates the recording medium S so as to bring it into contact with the photoreceptor drums 1. Thus, recording medium S is transported by transfer belt 11 until it reaches the transfer position, where the toner image on the photoreceptor drums 1 is transferred.

The transfer rollers 12 (12a, 12b, 12c, 12d) are arrayed in contact with the inner side of transfer belt 11, facing the four photoreceptor drums 1 (1a, 1b, 1c, 1d). Bias is applied to these transfer rollers 12 during transfer, and charge is applied to the recording medium S via the electrostatic transfer belt 11. The electrical field thus generated transfers the toner image on photoreceptor drums 1 to the recording medium S in contact with the photoreceptor drums 1.

A feed part 16 feeds the recording medium S to the image-forming stations Pa, Pb, Pc and Pd. In feed part 16, multiple sheets of recording medium S are contained in cassette 17. During image formation, a feed roller (half-moon roller) 18 and resist roller 19 are driven rotationally in conjunction with the image-forming operation. The feed roller 18 separates and feeds one sheet at a time of the recording medium S from cassette 7, sets the end of recording medium S against the resist roller 19 and then stops. Resist roller 19 then feeds the recording medium S to the electrostatic transfer belt 11 in synchronization with the rotation of the transfer belt 11 and the image writing position.

A fixing part 20 fixes the multicolor toner image transferred to recording medium S. The fixing part 20 has a heating roller 21a and a pressure roller 21b, which presses again the heating roller to apply heat and pressure to recording medium S. That is, as it passes through fixing part 20 the recording medium S to which the toner image formed on photoreceptor drum 1 has been transferred is transported by the pressure roller 21b as heat and pressure are applied by the heating roller 21a. A multicolor toner image is fixed on the surface of recording medium S in this way.

For the image forming operation, the cartridges 7 (7a, 7b, 7c, 7d) are driven in sequence in synchronization with the timing of image formation. The photoreceptor drums 1a, 1b, 1c, 1d are rotated counterclockwise in conjunction with this drive. The scanner units 3 corresponding to each cartridge 7 are also driven in sequence. In this way, the charging rollers 2 contribute a uniform charge to the outer cylindrical surfaces of the photoreceptor drums 1. The scanner units 3 then expose the outer cylindrical surfaces of the photoreceptor drums 1 based on image signals to thereby form electrostatic latent images on the outer surfaces of the photoreceptor drums 1. The developing rollers 40 inside the developing means 4 transfer toner to the low-potential areas of the electrostatic latent image to thereby form (develop) a toner image on the outer surfaces of the photoreceptor drums 1.

As the leading end of the toner image formed on the surface of the farthest upstream photoreceptor drum 1 is rotated to a point facing the transfer belt 11, the resist roller 19. rotates so as to align the initial printing position of the recording medium S with that facing point, and feeds the recording medium S to the transfer belt 11.

The recording medium S is sandwiched between an adsorption roller 22 and the transfer belt 11, and pressed against the outer surface of the transfer belt 11. Voltage is then applied between the transfer belt 11 and the adsorption roller 22. A charge is then induced in the recording medium S (which is a dielectric body) and in the dielectric layer of the transfer belt 11, electrostatically adsorbing the recording medium S onto the outer surface of the transfer belt 11. The recording medium S is thus stably adsorbed onto the electrostatic transfer belt 11 and transported to the farthest downstream transfer area.

As the recording medium S is transported in this way, the toner images on each photoreceptor drum 1 are transferred in sequence by the electrical fields formed between each transfer drum 1 and each transfer roller 12.

Once the four color toner images have been transferred to the recording medium S, it is curved away from the electrostatic transfer belt 11 by the curvature of the belt drive roller 13, and transported to the fixing part 20. Once the toner image has been heat fixed in the fixing part 20, the recording medium S is ejected from the unit by an ejection roller 23 from an ejection port 24 with the image facing down.

A method using a heating roller in the fixing part 20 was used as in example in FIG. 5, but the toner of the invention may be used favorably in other fixing methods. Another example is a mechanism in which the toner image is fixed by heating a heat-resistant polymer film with a heating element.

The present invention is explained in detail below using the following examples. However, these examples do not limit the present invention. Unless otherwise specified, the parts and percentages mentioned in the examples and comparative examples are all by mass.

### Crystalline Resin Manufacturing Example

### (Crystalline Resin 1)

50.0 parts of xylene, 175.0 parts of sebacic acid and 166.4 parts of 1,9-nonanediol were added to a pressure-resistant reactor equipped with a dropping funnel, a Liebig condenser and an agitator, and the temperature was raised to 210° C. The pressure here was 0.32 MPa. A mixture of 46.4 parts of styrene, 4.82 parts of acrylic acid and 3.26 parts of the polymerization initiator di-tert-butyl peroxide (Perbutyl D, Nippon Oil & Fats Co., Ltd.) dissolved in 10 parts of xylene was loaded into the dropping funnel, and added dropwise under pressure (0.31 MPa) over the course of 2 hours. After dropping, the mixture was further reacted for 3 hours at 210° C., completing solution polymerization. 0.80 parts of tetrabutoxy titanate were added, and a polycondensation reaction was performed for 3 hours at 210° C. at normal pressure in a nitrogen atmosphere. 0.010 additional parts of tetrabutoxy titanate were added, and reacted for 2 hours at 210° C. The mixture was returned to normal pressure, 34.1 parts of benzoic acid and 3.31 parts of trimellitic acid were added, and the mixture was reacted for a further 5 hours at 220° C. to obtain a crystalline resin 1. The physical properties of the resulting crystalline resin 1 are shown in Table 2.

### (Crystalline Resins 2 to 8, 10, 12, 13)

Reactions were performed as in the manufacturing example of crystalline resin 1 except that the added amounts of the. monomer, bireactive monomer (acrylic acid), initiator and other additives and the polycondensation reaction conditions were varied as shown in Table 1, to obtain crystalline resins 2 to 8, 10, 12 and 13. The physical properties of the resulting crystalline resins 2 to 8, 10, 12 and 13 are shown in Table 2.

### (Crystalline Resin 9)

A reaction was performed as in the manufacturing example of crystalline resin 1 except that the added amounts of the monomer, bireactive monomer (acrylic acid), initiator and other additives and the polycondensation reaction conditions were varied as shown in Table 1.

Next, the resulting resin was dissolved by adding methylethyl ketone (MEK) to a concentration of 10%, and this solution was re-suspended by gradually adding it to methanol in the amount of 20 times the MEK. The resulting suspension was washed with ½ the amount of methanol used in re-suspension, and the filtered particles were vacuum dried for 48 hours at 35° C. to obtain a crystalline resin 9.

The physical properties of the resulting crystalline resin 9 are shown in Table 2.

### (Crystalline Resin 11)

A reaction was performed as in the manufacturing example of crystalline resin 1 except that the added amounts of the monomer, bireactive monomer (acrylic acid), initiator and other additives and the polycondensation reaction conditions were varied as shown in Table 1.

Next, the resulting resin was dissolved by adding MEK to a concentration of 10%, and this solution was re-suspended by gradually adding it to methanol in the amount of 20 times the MEK. The resulting suspension was washed with ½ the amount of methanol used in re-suspension, and the filtered particles were vacuum dried for 48 hours at 35° C. The vacuum dried particles were then re-suspended by adding MEK to a concentration of 10%, and this solution was re-suspended by gradually adding it to n-hexane in the amount of 20 times the MEK. The resulting suspension was washed with ½ the amount of n-hexane used in re-suspension, and the filtered particles were vacuum dried for 48 hours at 35° C. to obtain a crystalline resin 11.

The physical properties of the crystalline resin 11 are shown in Table 2.

### Polar Resin Manufacturing Example

### (Polar Resin 1)

The following polyester monomers were-loaded into an autoclave equipped with a pressure-reducing unit, a water separator, a nitrogen gas introduction unit, a temperature gauge and an agitator, and reacted for 15 hours at 220° C. at normal pressure in a nitrogen atmosphere.

| | |
|---|---|
| Terephthalic acid | 21.0 parts |
| Isophthalic acid | 21.0 parts |
| Bisphenol A-propylene oxide 2-mole adduct | 89.5 parts |
| Bisphenol A-propylene oxide 3-mole adduct | 23.0 parts |
| Potassium oxalate titanate | 0.030 parts |

This was then reacted for 1 hour under reduced pressure of 10 mmHg to 20 mmHg, to obtain a polar resin 1. The polar resin 1 had a Tg of 74.8° C., and an acid value of 8.2 mg KOH/g.

### Toner Manufacturing Examples

### (Toner 1)

A suspension-polymerized toner was manufactured by the following methods.

First, the following materials were dissolved and mixed uniformly, at 100 r/min in a propeller-type agitator, to prepare a polymerizable monomer composition.

| | | |
|---|---|---|
| Styrene | 70.0 | parts |
| n-butyl acrylate | 30.0 | parts |
| Polar resin 1 | 10.0 | parts |
| Crystalline resin 1 | 15.0 | parts |
| Pigment blue 15:3 | 7.5 | parts |
| Paraffin wax (HNP-5: Nippon Seiro Co., Ltd., | 9.0 | parts |
| melting point 60° C.) | | |
| Copolymer FCA-1001-NS containing sulfonic acid | 1.0 | part |
| groups (Fujikura Kasei Co., Ltd.) | | |
| Charge control agent Bontron E-88 (Orient Chemical | 0.5 | parts |
| Industries Co., Ltd.) | | |

Next, this polymerizable monomer composition was heated to 60° C., a Cavitron (Eurotech Co., Ltd.) was introduced, and the mixture was mixed. The rotator speed G (m/s) was 40, and the mixing time was 30 minutes. 8.0 parts of the polymerization initiator 2,2′-azobis(2,4-dimethylvaleronitrile) were then dissolved in the polymerizable monomer composition.

850 parts of a 0.1 mol/L Na₃PO₄ aqueous solution and 8.0 parts of 10% hydrochloric acid were added to a container equipped with a high-speed Cleamix agitator (M Technique Co., Ltd.), and heated to 60° C. with the rotation adjusted to 80 rps. 68 parts of a 1.0 mol/L CaCl₂ aqueous solution were added, to prepare an aqueous medium containing a fine, hardly water soluble dispersant Ca₃ (PO₄)₂.

A polymerization initiator was added to the polymerizable monomer composition, after 5 minutes the 60° C. polymerizable monomer composition was added to the aqueous medium, which had been heated to 60° C., and the mixture was granulated for 15 minutes with the Cleamix rotating at 80 rps. The propeller blade in the high-speed agitator was replaced with a mixer, the mixture was reacted for 5 hours at 70° C. with reflux, the liquid temperature was raised to 80° C., and the reaction was continued for 2 hours. After completion of polymerization, the liquid temperature was lowered to about 20° C., and dilute hydrochloride acid was added to lower the pH of the aqueous medium to 3.0 or less and dissolve the hardly water soluble dispersant. After being washed, the resulting moist toner particles were crushed, and dried with a continuous instant pneumatic dryer (FJD-4 Flash Dryer, Seishin Enterprise Co., Ltd.) to obtain a toner. For the drying conditions, 90° C. air was blown in at a linear rate of 16.5 m/second, and the wet toner particles were supplied continuously at 20 kg/hr. Drying took 0.7 seconds.

1.6 parts of silica fine particles with a number-average particle diameter of 40 nm of the primary particles were added as an additive to 100 parts of the resulting toner particles, and mixed with a Henschel mixer (Mitsui Miike Chemical Engineering Machinery, Co., Ltd.) to obtain a toner 1. The physical properties of the toner 1 are shown in Table 4.

### (Toners 2 to 22, 24 to 31, 33 to 37)

Toners 2 to 22, 24 to 31 and 33 to 37 were obtained as in the manufacturing example of Toner 1 except that the type of crystalline resin, the type of polar resin, the added amounts and the polymerization conditions were varied as shown in Table 3. The physical properties are shown in Table 4.

### (Toner 23)

### (Preparation of Resin Dispersion A)

| | |
|---|---|
| Styrene | 285 parts |
| Butyl acrylate | 95 parts |
| Acrylic acid | 8 parts |
| Dodecyl mercaptane | 4 parts |

These materials were mixed in advance and dissolved to prepare a solution (a). Meanwhile, 7 parts of a non-ionic surfactant (Nonipol™, Sanyo Chemical Industries, Ltd.) and 10 parts of an anionic surfactant (Neogen R™, DKS Co. Ltd.) were dissolved in 520 parts of ion-exchange water to prepare a solution (b). Solutions (a) and (b) were placed in a flask, emulsified by dispersion, and slowly mixed for 10 minutes. 50 parts of ion-exchange water containing 6 parts of dissolved ammonium persulfate were added, and nitrogen exchange was performed. The flask was then agitated while being heated in an oil bath until the contents were at 90° C., and emulsion polymerization was continued as is for 6 hours. The reaction solution was then cooled to room temperature to obtain a resin dispersion A.

### (Preparation of Colorant Dispersion A)

| | |
|---|---|
| Pigment blue 15:3 | 70 parts |
| Anionic surfactant (Neogen ™, DKS Co. Ltd.) | 3 parts |
| Ion-exchange water | 400 parts |

These materials were mixed and dissolved, and dispersed, with a homogenizer (IKA(R) Werke GmbH & Co, KG Ultra-Turrax™) to obtain a colorant dispersion A.

### (Preparation of Release Agent Dispersion A)

| | |
|---|---|
| Paraffin wax (HNP-5: Nippon Seiro Co., Ltd., | 100 parts |
| melting point 60° C.) | |
| Anionic surfactant (Pionin A-45-D, Takemoto Oil & | 2 parts |
| Fat Co., Ltd.) | |
| Ion-exhange water | 500 parts |

These materials were mixed and dissolved, dispersed with a homogenizer (IKA(R) Werke GmbH & Co. KG Ultra-Turrax™), and then dispersed with a pressure discharge homogenizer to obtain a release agent dispersion A with release agent (paraffin wax) dispersed therein.

### (Preparation of Crystalline Polyester Dispersion A)

200 parts of the crystalline resin 1 were added to 800 parts of distilled water and heated to 80° C., after which the pH was adjusted to 9.0 with ammonia, 0.4 parts (as active component) of an anionic surfactant (DKS Co. Ltd. Neogen RK) were added, and the mixture was dispersed for 7 minutes at 8000 rpm with a homogenizer (IKA® Japan, Ultra-Turrax™ T50) while being heated at 80° C. to obtain a crystalline polyester dispersion A.

| | |
|---|---|
| Resin dispersion A | 300 parts |
| Colorant dispersion A | 50 parts |
| Release agent dispersion A | 60 parts |
| Crystalline polyester dispersion A | 45 parts |
| Cationic surfactant (Sanizol B50 ™, Kao | 4 parts |
| Corporation) | |
| Ion-exchange water | 500 parts |

These components were mixed and dispersed in a round-bottom stainless steel flask with a homogenizer (IKA(R) Werke GmbH & Co. KG Ultra-Turrax™ T50) to prepare a liquid mixture which was then heated to 50° C. with agitation in a heating oil bath, and maintained for 30 minutes at 50° C. to form agglomerated particles. Next, 6 parts of sodium dodecylbenzene sulfonate (Neogen SC, DKS Co. Ltd.) were added as an anionic surfactant to the agglomerated particle dispersion, which was then heated to 90° C. Sodium hydroxide was then added appropriately to maintain a pH of 4.0 or less in the system, which was then maintained as is for 5 hours to fuse the agglomerated particles. This was then cooled to 45° C. at a cool-down rate of 1.0° C./min, filtered and washed thoroughly with ion-exchange water, and ion-exchange water was added to adjust the concentration of the agglomerated particles in the dispersion to 20% and obtain a core particle dispersion.

### (Manufacture of Resin Fine Particle Dispersion 1)

The following monomers were loaded into a reaction vessel equipped with a mixer, a condenser, a thermometer and a nitrogen introduction tube, 0.03 parts of tetrabutoxy titanate were added as an esterification catalyst, the temperature was raised to 220° C. in a nitrogen atmosphere, and a reaction was performed for 5 hours with agitation.

| | |
|---|---|
| Bisphenol A propylene oxide 2-mole adduct (BPO—PO) | 49.5 parts |
| Ethylene glycol | 8.0 parts |
| Terephthalic acid | 22.3 parts |
| Isophthalic acid | 15.0 parts |
| Anhydrous trimellitic acid | 5.2 parts |

Next, the reaction vessel was depressurized to 5 mmHg to 20 mmHg, and a further reaction was performed for 5 hours to obtain a polyester resin.

Next, 100.0 parts of the resulting polyester resin, 90.0 parts of tetrahydrofuran, 2.0 parts of diethylamino ethanol (DMAE) and 0.5 parts of sodium dodecylbenzene sulfonate (DBS) were loaded into a reaction vessel equipped with a mixer, a condenser, a thermometer and a nitrogen introduction tube, and dissolved by heating to 80° C. 300.0 mass parts of ion-exchange water were then added at 80° C. with agitation to disperse the mixture, and the resulting aqueous dispersion was transferred to a distillation unit and distilled until the distillate temperature reached 100° C. The resulting aqueous dispersion was cooled, and ion-exchange water was added to adjust the resin concentration in the dispersion to 20%. This was then used as resin fine particle dispersion 1.

### (Fixing of Resin Fine Particles)

500.0 parts (solids 100.0 parts) of the core particle dispersion was added to a reaction vessel equipped with a reflux condenser, a mixer and a thermometer, agitated as 25.0 parts (solids 5.0 parts) of the resin fine particle dispersion 1 were gradually added, and then agitated for 15 minutes at 200 rotations/minute. Next, the temperature of this dispersion was maintained at 60° C. with a heating oil bath as 0.3 mol/L hydrochloric acid was added dropwise at a rate of 1.0 parts/minute to adjust the pH of the dispersion to 1.5, after which agitation was continued for 2 hours. This dispersion was cooled to 20° C. and washed thoroughly with ion-exchange water, and the resulting wet toner particles were crushed and dried with a continuous instant pneumatic dryer (FJD-4 Flash Dryer, Seishin Enterprise Co., Ltd.) to obtain a toner particle. For the drying conditions, 90° C. air was blown in at a linear rate of 16.5 m/second, and the wet toner particles were supplied continuously at 20 kg/hr. Drying took 0.7 seconds.

1.6 parts-of silica fine particles with a number-average particle diameter of 40 nm of the primary particles were added as an additive to 100 parts of the resulting toner particles, and mixed with a Henschel mixer (Mitsui Miike Chemical Engineering Machinery, Co., Ltd.) to obtain a toner 23. The physical properties of toner 23 are shown in Table 4.

### (Toner 32)

Toner 32 was obtained as in the manufacturing example of Toner 1 except that the toner drying step was performed with a constant temperature dryer (Satake Chemical Equipment Mfg., Ltd. 41-S5). Specifically, the internal temperature of the constant temperature dryer was adjusted to 40° C. Next, the wet toner particles were spread uniformly on a stainless steel tray, which was placed in the constant temperature dryer, left for 72 hours, and removed. The physical properties of the toner 32 are shown in Table 4.

### Example 1

Using Toner 1 as a non-magnetic one-component developer, and a modified commercial laser printer (LBP-5400, Canon Inc.) as the image-forming apparatus, an image evaluation was performed at 23° C., RH 50% with A4 color laser copy paper (Canon Inc., 80 g/m²). The printer was modified as follows.

The gears and software of the evaluation unit were changed to obtain a process speed of 360 mm/sec.

A cyan cartridge was used as the cartridge for evaluation. That is, the product toner was removed from a commercial cyan cartridge, the interior was cleaned out by air blowing, and the cartridge was filled with 150 g of the toner for evaluation. The product toners were also removed from the magenta, yellow and black stations, the remaining toner detection mechanisms were disabled, and the magenta, yellow and black cartridges were replaced before the evaluation.

### (1) Low-Temperature Fixability During High-Speed Fixing

Using the evaluation unit described above with 105 g/m² business 4200 (Xerox Corporation) evaluation paper, the temperature setting was changed in 3° C. increments in the range of 130° C. to 220° C., and an original image was output at each temperature.

For the original image, an image was output having a 10 mm square solid patch image (toner laid-on level 0.90 mg/cm²) in the center of each of 9 partitions of the paper surface.

Next, a rubbing resistance test was performed with the fixed images output at each temperature to evaluate the minimum fixable temperature. The fixed image concentration of each patch was measured along with the image concentration after the patch had been-rubbed 5 times with Silbon paper with a load of 50 g/cm², and fixing was deemed possible when average value of the measured concentration loss was 10% or less. The minimum temperature at which fixation was possible was defined as the minimum fixable temperature.

Image concentration was measured using a Macbeth Reflection Densitometer RD918 (Macbeth Co.).

A: Minimum fixable temperature 160° C. or less

B: Minimum fixable temperature over 160° C. to 175° C.

C: Minimum fixable temperature over 175° C. to 19° C.

D: Minimum fixable temperature over 190° C., or no fixable temperature

### (2) Hot Offset Resistance

A 5 cm×5 cm solid image with a toner laid-on level of 0.20 mg/cm² was created at the center leading edge of the evaluation paper, and the trailing edge of the paper in the direction of feed was observed. The temperature of the fixation heating part when hot offset occurred was considered the hot offset occurrence temperature, and was evaluated according to the following standard (hot offset is a phenomenon in which part of the fixed image adheres to a component surface in the fixing device, and is then fixed to the recording material in the next pass).

A: 180° C. or more

B: 175° C. to less than 180° C.

C: 170° C. to less than 175° C.

D: Less than 170° C.

### (3) Charging Uniformity

The particle size distribution of the toner in the cartridge initially and after 10,000 sheets of output was measured by the methods described above for measuring weight-average particle diameter (D4). The particle size change rate was calculated based on the following formula based on the resulting weight-average particle size (D4) measurements, and evaluated based on the following standard. The more uniform the charge distribution of the toners, the smaller the particle size change rate because this means that the toners of each particle size are consumed uniformly during long-term use.

Particle size change rate (%)=Initial weight-average particle size (D4)/Weight-average particle size (D4) after 10,000 sheets×100

A: 95% to 100%

B: 85% to less than 95%

C: 75% to less than 85%

D: Less than 75%

### (4) Image Fogging

Using the modified unit explained above, the durability of the toner was evaluated by an endurance test. As the conditions for the endurance test, 3000 copies a day of an original image with a print ratio of 2% were printed in a high-temperature, high-humidity environment (30° C., 80% RH), for a total of 12,000 images in 4 days. An evaluation was performed every 1000 sheets and the first sheet on each day, and a solid white image was printed and evaluated according to the following evaluation standard.

Using a Reflectmeter Model TC-6DS (Tokyo Denshoku Co., Ltd.), the reflectance of standard paper and of the white parts of the printout images was measured, and fogging (%) was calculated by the following formula. Measurement was performed with a blue filter installed as the filter.

The worst value obtained during the endurance test was evaluated according to the following standard.

A: Less than 1.0%

B: 1.0% to less than 2.0%

C: 2.0% to less than 3.0%

D: 3.0% or more

Fogging (%)=Reflectance, of standard paper (%)−reflectance of sample (%)

### (5) Storage Stability

Blocking resistance was evaluated as an evaluation of storage stability. About 10 g of toner was placed in a 100 ml resin cup and left for 3 days at 55° C., and blocking was evaluated visually.

A: No aggregates observed

B: Some aggregates observed, but easily broken up

C: Aggregates observed, but easily broken up

D: Many aggregates observed, but could be broken up by shaking the cup

E: Very many aggregates observed, not easily broken up

When Toner 1 was evaluated under these conditions, Toner 1 exhibited extremely good results in terms of low-temperature fixability during high-speed output. Hot offset resistance, charge uniformity, fogging and storage stability were also good. The detailed results are shown in Table 5.

### Examples 2 to 27

Toners 2 to 27 were evaluated under the same conditions as in Example 1. The results are shown in Table 5.

### Comparative Examples 1 to 10

Toners 28 to 37 were evaluated under the same conditions as in Example 1. The results are shown in Table 5.

TABLE 1

| | Added amount | | | | | | | | | |
|---|---|---|---|---|---|---|---|---|---|---|
| Crys- | | | | | | | Catalyst | | | |
| talline | Acid | Alcohol | | Acrylic | X | Initiator (parts) | (parts) | | | Re- |
| resin | component | component | Styrene | acid | (mass | Di-tert- | Tetrabutyl | | Polycondensation | precipi- |
| No. | (parts) | (parts) | (parts) | (parts) | ratio) | butylperoxide | titanate | Other (parts) | step conditions | tation |
| 1 | Sebacic acid | 1,9-nonanediol | 46.4 | 4.82 | 87.0/13.0 | 3.26 | 0.80 | Benzoic acid 34.1 | 210° C., 5 hours | — |
| | 175.0 | 166.4 | | | | | | Trimellitic acid 3.31 | | |
| 2 | Sebacic acid | 1,9-nonanediol | 0 | 0 | 100/0 | 0 | 0.80 | Benzoic acid 42.3 | 210° C., 5 hours | — |
| | 175.0 | 166.4 | | | | | | Trimellitic acid 4.41 | | |
| 3 | Sebacic acid | 1,9-nonanediol | 109.0 | 10.92 | 74.0/26.0 | 7.65 | 0.80 | Benzoic acid 23.8 | 210° C., 5 hours | — |
| | 175.0 | 166.4 | | | | | | Trimellitic acid 3.45 | | |
| 4 | Sebacic acid | 1,10- | 0 | 0 | 100/0 | 0 | 0.80 | Benzoic acid 42.3 | 210° C., 5 hours | — |
| | 175.0 | decanediol | | | | | | Trimellitic acid 3.31 | | |
| | | 181.0 | | | | | | | | |
| 5 | Sebacic acid | 1,8-octanediol | 74.4 | 7.33 | 80.0/20.0 | 5.22 | 0.80 | Benzoic acid 29.9 | 210° C., 5 hours | — |
| | 175.0 | 151.8 | | | | | | Trimellitic acid 4.83 | | |
| 6 | Sebacic acid | 1,8-octanediol | 36.7 | 3.68 | 89.0/11.0 | 2.58 | 0.80 | Benzoic acid 36.0 | 210° C., 5 hours | — |
| | 175.0 | 151.8 | | | | | | Trimellitic acid 5.38 | | |
| 7 | Sebacic acid | 1,12- | 30.6 | 2.91 | 92.0/8.0 | 2.15 | 0.80 | Benzoic acid 37.3 | 210° C., 5 hours | — |
| | 175.0 | dodecanediol | | | | | | Trimellitic acid 4.41 | | |
| | | 210.1 | | | | | | | | |
| 8 | Sebacic acid | 1,12- | 10.9 | 1.02 | 97.0/3.0 | 0.76 | 0.80 | Benzoic acid 40.5 | 210° C., 5 hours | — |
| | 175.0 | dodecanediol | | | | | | Trimellitic acid 4.14 | | |
| | | 210.1 | | | | | | | | |
| 9 | Sebacic acid | 1,10- | 0 | 0 | 100/0 | 0 | 0.80 | Benzoic acid 42.3 | 210° C., 5 hours | Yes |
| | 175.0 | decanediol | | | | | | Trimellitic acid 3.31 | | |
| | | 181.0 | | | | | | | | |
| 10 | Sebacic acid | 1,8-nonanediol | 132.6 | 13.76 | 70.0/30.0 | 9.31 | 0.80 | Benzoic acid 19.0 | 210° C., 5 hours | — |
| | 175.0 | 166.4 | | | | | | Trimellitic acid 4.00 | | |
| 11 | Sebacic acid | 1,9-nonanediol | 46.4 | 4.82 | 87.0/13.0 | 3.26 | 0.80 | Benzoic acid 34.1 | 210° C., 5 hours | Yes |
| | 175.0 | 166.4 | | | | | | Trimellitic acid 3.31 | | |
| 12 | Sebacic acid | 1,8-octanediol | 74.4 | 7.33 | 60.0/40.0 | 5.22 | 0.80 | Benzoic acid 29.9 | 210° C., 5 hours | — |
| | 175.0 | 151.8 | | | | | | Trimellitic acid 4.83 | | |
| 13 | Sebacic acid | 1,12- | 0 | 0 | 100/0 | 0 | 0.80 | Benzoic acid 42.3 | 210° C., 5 hours | — |
| | 175.0 | dodecanediol | | | | | | Trimellitic acid 3.59 | | |
| | | 210.1 | | | | | | | | |

In Table 1, X means “total amount of condensed resin component monomers/total amount of vinyl resin component monomers (mass ratio)”.

TABLE 2

| | | | | | Area ratio of |
|---|---|---|---|---|---|
| | | | Crystalline | | endothermic |
| | | | segments/ | Weight- | peak at |
| | | | amorphous | average | endothermic |
| Crystalline | Melting | Acid | segments | molecular | temperature of |
| resin No. | point | value | (mass ratio) | weight | 50° C. or less |
| 1 | 69° C. | 2.4 | 87/13 | 21500 | 9.0% |
| 2 | 73° C. | 3.2 | 100/0 | 19400 | 2.0% |
| 3 | 65° C. | 2.5 | 74/26 | 25700 | 19.0% |
| 4 | 80° C. | 2.4 | 100/0 | 19800 | 3.0% |
| 5 | 51° C. | 3.5 | 80/20 | 26400 | 16.0% |
| 6 | 56° C. | 3.9 | 89/11 | 24300 | 13.0% |
| 7 | 84° C. | 3.2 | 92/8 | 21300 | 8.0% |
| 8 | 88° C. | 3.0 | 97/3 | 21100 | 5.0% |
| 9 | 83° C. | 2.4 | 100/0 | 20800 | 1.0% |
| 10 | 62° C. | 2.9 | 70/30 | 22000 | 25.0% |
| 11 | 71° C. | 2.4 | 87/13 | 21300 | 0.2% |
| 12 | 49° C. | 2.9 | 60/40 | 24200 | 25.0% |
| 13 | 94° C. | 2.6 | 100/0 | 20100 | 2.0% |

TABLE 3

| | | | | | | | | Heating | |
|---|---|---|---|---|---|---|---|---|---|
| | | Polar | Polar resin | Crystalline | Styrene/butyl | T1 − Tm | | holding | |
| Toner | Crystalline | resin | content (mass | resin content | acrylate content | T1 | (C.) | time | Drying |
| No. | resin No. | No. | parts) | (mass parts) | (mass parts) | (° C.) | (° C.) | (minutes) | method |
| 1 | 1 | 1 | 10 | 15 | 70/30 | 98 | 29 | 300 | Flash jet |
| 2 | 2 | 1 | 10 | 15 | 70/30 | 98 | 4 | 300 | Flash jet |
| 3 | 1 | 1 | 7 | 15 | 70/30 | 98 | 29 | 300 | Flash jet |
| 4 | 1 | 1 | 14 | 15 | 70/30 | 98 | 29 | 300 | Flash jet |
| 5 | 3 | 1 | 10 | 15 | 70/30 | 98 | 33 | 300 | Flash jet |
| 6 | 4 | 1 | 10 | 15 | 70/30 | 98 | 18 | 300 | Flash jet |
| 7 | 1 | 1 | 10 | 22 | 75/25 | 98 | 29 | 300 | Flash jet |
| 8 | 1 | 1 | 10 | 9 | 67/33 | 98 | 29 | 300 | Flash jet |
| 9 | 1 | 1 | 10 | 15 | 63/37 | 98 | 29 | 300 | Flash jet |
| 10 | 1 | 1 | 10 | 15 | 66/34 | 98 | 29 | 300 | Flash jet |
| 11 | 1 | 1 | 10 | 15 | 75/25 | 98 | 29 | 300 | Flash jet |
| 12 | 1 | 1 | 10 | 15 | 80/20 | 98 | 29 | 300 | Flash jet |
| 13 | 1 | 1 | 10 | 24 | 70/30 | 98 | 29 | 300 | Flash jet |
| 14 | 1 | 1 | 10 | 20 | 70/30 | 98 | 29 | 300 | Flash jet |
| 15 | 1 | 1 | 10 | 12 | 70/30 | 98 | 29 | 300 | Flash jet |
| 16 | 1 | 1 | 10 | 8 | 70/30 | 98 | 29 | 300 | Flash jet |
| 17 | 5 | 1 | 10 | 15 | 70/30 | 98 | 47 | 300 | Flash jet |
| 18 | 6 | 1 | 10 | 15 | 70/30 | 98 | 42 | 300 | Flash jet |
| 19 | 7 | 1 | 10 | 15 | 70/30 | 98 | 14 | 300 | Flash jet |
| 20 | 8 | 1 | 10 | 15 | 70/30 | 98 | 10 | 300 | Flash jet |
| 21 | 9 | 1 | 10 | 15 | 70/30 | 98 | 15 | 300 | Flash jet |
| 22 | 10 | 1 | 10 | 15 | 70/30 | 98 | 36 | 300 | Flash jet |
| 23 | 1 | None | None | 15 | 75/25 | 98 | 29 | 300 | Flash jet |
| 24 | 1 | 1 | 10 | 15 | 70/30 | 65 | −4 | 300 | Flash jet |
| 25 | 1 | 1 | 10 | 15 | 70/30 | 75 | −6 | 300 | Flash jet |
| 26 | 1 | 1 | 10 | 15 | 70/30 | 98 | 29 | 45 | Flash jet |
| 27 | 1 | 1 | 10 | 15 | 70/30 | 98 | 29 | 65 | Flash jet |
| 28 | None | 1 | 10 | — | 70/30 | 98 | — | 300 | Flash jet |
| 29 | 1 | 1 | 2 | 15 | 70/30 | 98 | 29 | 300 | Flash jet |
| 30 | 1 | 1 | 25 | 15 | 70/30 | 98 | 29 | 300 | Flash jet |
| 31 | 11 | 1 | 10 | 15 | 70/30 | 98 | 27 | 300 | Flash jet |
| 32 | 1 | 1 | 10 | 15 | 70/30 | 98 | 29 | 300 | Drying tray |
| 33 | 1 | 1 | 10 | 15 | 70/30 | Not | — | — | Flash jet |
| | | | | | | performed | | | |
| 34 | 12 | 1 | 10 | 15 | 70/30 | 98 | 49 | 300 | Flash jet |
| 35 | 13 | 1 | 10 | 15 | 70/30 | 98 | 4 | 300 | Flash jet |
| 36 | 1 | 1 | 10 | 2 | 70/30 | 98 | 29 | 60 | Flash jet |
| 37 | 8 | 1 | 10 | 8 | 70/30 | 98 | 18 | 300 | Flash jet |

TABLE 4

| | | | | Weight- | | | | | |
|---|---|---|---|---|---|---|---|---|---|
| | | | Weight- | average | | | | | |
| | | Toner | average | particle | G″ at | | Minimum | G″ peak top | |
| | Toner | Tg | molecular | diameter D4 | 20° C. | Shoulder | value of | temperature | G″ peak top |
| | No. | (° C.) | weight (×100) | (μm) | (Pa) | temperature | Curve 1 | (° C.) | value (Pa) |
| Example 1 | 1 | 54.1 | 712 | 6.09 | 4.0 × 10⁸ | 38° C. | −0.24 | 54 | 9.0 × 10⁸ |
| Example 2 | 2 | 53.7 | 730 | 6.25 | 3.5 × 10⁸ | 41° C. | −0.21 | 54 | 8.0 × 10⁸ |
| Example 3 | 3 | 53.1 | 695 | 6.12 | 1.8 × 10⁸ | 38° C. | −0.25 | 54 | 7.0 × 10⁸ |
| Example 4 | 4 | 54.0 | 701 | 6.00 | 9.0 × 10⁸ | 38° C. | −0.19 | 54 | 2.0 × 10⁹ |
| Example 5 | 5 | 52.9 | 731 | 6.25 | 4.0 × 10⁸ | 32° C. | −0.25 | 54 | 9.0 × 10⁸ |
| Example 6 | 6 | 54.0 | 720 | 6.17 | 4.0 × 10⁸ | 44° C. | −0.19 | 54 | 9.0 × 10⁸ |
| Example 7 | 7 | 53.0 | 692 | 5.97 | 4.0 × 10⁸ | 38° C. | −0.28 | 54 | 9.0 × 10⁸ |
| Example 8 | 8 | 52.4 | 721 | 5.89 | 4.0 × 10⁸ | 38° C. | −0.17 | 54 | 9.0 × 10⁸ |
| Example 9 | 9 | 52.8 | 736 | 6.04 | 4.0 × 10⁸ | 38° C. | −0.25 | 45 | 9.0 × 10⁸ |
| Example 10 | 10 | 52.8 | 719 | 6.23 | 4.0 × 10⁸ | 38° C. | −0.24 | 49 | 9.0 × 10⁸ |
| Example 11 | 11 | 52.9 | 693 | 6.05 | 4.0 × 10⁸ | 38° C. | −0.19 | 61 | 9.0 × 10⁸ |
| Example 12 | 12 | 52.2 | 727 | 6.30 | 4.0 × 10⁸ | 38° C. | −0.19 | 66 | 9.0 × 10⁸ |
| Example 13 | 13 | 53.1 | 701 | 6.25 | 2.5 × 10⁸ | 38° C. | −0.25 | 54 | 4.0 × 10⁸ |
| Example 14 | 14 | 52.8 | 714 | 6.12 | 3.0 × 10⁸ | 38° C. | −0.24 | 54 | 7.0 × 10⁸ |
| Example 15 | 15 | 52.9 | 715 | 6.05 | 7.0 × 10⁸ | 38° C. | −0.19 | 54 | 2.0 × 10⁹ |
| Example 16 | 16 | 53.0 | 691 | 6.32 | 8.0 × 10⁸ | 38° C. | −0.17 | 54 | 5.0 × 10⁹ |
| Example 17 | 17 | 53.3 | 730 | 6.40 | 4.0 × 10⁸ | 34° C. | −0.26 | 54 | 9.0 × 10⁸ |
| Example 18 | 18 | 52.6 | 729 | 6.08 | 4.0 × 10⁸ | 36° C. | −0.24 | 54 | 9.0 × 10⁸ |
| Example 19 | 19 | 54.0 | 720 | 6.34 | 4.0 × 10⁸ | 41° C. | −0.18 | 54 | 9.0 × 10⁸ |
| Example 20 | 20 | 53.0 | 716 | 6.16 | 4.0 × 10⁸ | 43° C. | −0.17 | 54 | 9.0 × 10⁸ |
| Example 21 | 21 | 52.9 | 716 | 6.34 | 4.0 × 10⁸ | 43° C. | −0.18 | 54 | 9.0 × 10⁸ |
| Example 22 | 22 | 52.5 | 712 | 5.91 | 4.0 × 10⁸ | 33° C. | −0.29 | 54 | 9.0 × 10⁸ |
| Example 23 | 23 | 53.3 | 690 | 5.87 | 4.0 × 10⁸ | 38° C. | −0.19 | 54 | 9.0 × 10⁸ |
| Example 24 | 24 | 52.8 | 698 | 6.05 | 4.0 × 10⁸ | 38° C. | −0.16 | 54 | 9.0 × 10⁸ |
| Example 25 | 25 | 53.7 | 716 | 5.96 | 4.0 × 10⁸ | 38° C. | −0.21 | 54 | 9.0 × 10⁸ |
| Example 26 | 26 | 53.4 | 700 | 6.04 | 4.0 × 10⁸ | 38° C. | −0.19 | 54 | 9.0 × 10⁸ |
| Example 27 | 27 | 53.8 | 714 | 5.99 | 4.0 × 10⁸ | 38° C. | −0.22 | 54 | 9.0 × 10⁸ |
| Comparative Example 1 | 28 | 53.3 | 695 | 6.30 | 4.0 × 10⁸ | None | −0.12 | 54 | 9.0 × 10⁸ |
| Comparative Example 2 | 29 | 52.2 | 695 | 6.20 | 7.0 × 10⁷ | 38° C. | −0.24 | 54 | 9.0 × 10⁸ |
| Comparative Example 3 | 30 | 54.0 | 719 | 5.85 | 4.0 × 10⁹ | 38° C. | −0.24 | 54 | 9.0 × 10⁸ |
| Comparative Example 4 | 31 | 53.5 | 696 | 5.99 | 4.0 × 10⁸ | None | −0.17 | 54 | 9.0 × 10⁸ |
| Comparative Example 5 | 32 | 52.9 | 698 | 6.45 | 4.0 × 10⁸ | None | −0.17 | 54 | 9.0 × 10⁸ |
| Comparative Example 6 | 33 | 53.8 | 694 | 6.20 | 4.0 × 10⁸ | None | −0.13 | 54 | 9.0 × 10⁸ |
| Comparative Example 7 | 34 | 52.6 | 703 | 6.16 | 4.0 × 10⁸ | 25° C. | −0.25 | 54 | 9.0 × 10⁸ |
| Comparative Example 8 | 35 | 53.5 | 723 | 6.17 | 4.0 × 10⁸ | 51° C. | −0.16 | 54 | 9.0 × 10⁸ |
| Comparative Example 9 | 36 | 52.2 | 697 | 6.32 | 4.0 × 10⁸ | 38° C. | −0.12 | 54 | 9.0 × 10⁸ |
| Comparative Example 10 | 37 | 53.4 | 716 | 6.45 | 4.0 × 10⁸ | 43° C. | −0.11 | 54 | 9.0 × 10⁸ |

TABLE 5

| | | Fixability | | | | |
|---|---|---|---|---|---|---|
| | | Low-temperature | | Durability | | |
| | Toner | fixability during high- | | Charging | Fogging | Storage |
| Example | No. | speed fixing | Hot offset resistance | uniformity | evaluation | stability |
| Example 1 | 1 | A (154° C.) | A (184° C.) | A (98.7%) | A (0.42%) | A |
| Example 2 | 2 | A (157° C.) | A (187° C.) | A (98.1%) | A (0.43%) | A |
| Example 3 | 3 | A (151° C.) | A (183° C.) | A (96.2%) | A (0.72%) | B |
| Example 4 | 4 | B (166° C.) | A (186° C.) | A (96.3%) | A (0.52%) | A |
| Example 5 | 5 | A (151° C.) | A (183° C.) | A (96.2%) | A (0.71%) | B |
| Example 6 | 6 | B (163° C.) | A (185° C.) | A (98.2%) | A (0.43%) | A |
| Example 7 | 7 | A (148° C.) | B (179° C.) | B (93.8%) | A (0.87%) | B |
| Example 8 | 8 | B (163° C.) | A (184° C.) | A (98.5%) | A (0.46%) | A |
| Example 9 | 9 | A (151° C.) | A (181° C.) | A (96.1%) | A (0.72%) | B |
| Example 10 | 10 | A (154° C.) | A (183° C.) | A (96.8%) | A (0.61%) | A |
| Example 11 | 11 | A (160° C.) | A (187° C.) | A (97.2%) | A (0.41%) | A |
| Example 12 | 12 | B (163° C.) | A (189° C.) | A (97.5%) | A (0.4%) | A |
| Example 13 | 13 | A (148° C.) | B (179° C.) | B (93.8%) | A (0.87%) | B |
| Example 14 | 14 | A (151° C.) | A (181° C.) | A (95.5%) | A (0.62%) | A |
| Example 15 | 15 | A (157° C.) | A (184° C.) | A (97.9%) | A (0.55%) | A |
| Example 16 | 16 | B (163° C.) | A (187° C.) | A (98.5%) | A (0.46%) | A |
| Example 17 | 17 | A (148° C.) | B (179° C.) | B (93.8%) | A (0.87%) | B |
| Example 18 | 18 | A (151° C.) | A (181° C.) | A (95.5%) | A (0.62%) | A |
| Example 19 | 19 | A (157° C.) | A (184° C.) | A (97.9%) | A (0.55%) | A |
| Example 20 | 20 | B (163° C.) | A (187° C.) | A (98.5%) | A (0.46%) | A |
| Example 21 | 21 | B (166° C.) | A (189° C.) | A (98.1%) | A (0.43%) | A |
| Example 22 | 22 | A (148° C.) | B (176° C.) | B (93.8%) | A (0.87%) | B |
| Example 23 | 23 | A (157° C.) | B (176° C.) | B (93.6%) | B (1.28%) | B |
| Example 24 | 24 | B (163° C.) | A (187° C.) | A (97.2%) | A (0.52%) | A |
| Example 25 | 25 | A (160° C.) | A (186° C.) | A (97.1%) | A (0.54%) | A |
| Example 26 | 26 | A (160° C.) | A (188° C.) | A (97.6%) | A (0.52%) | A |
| Example 27 | 27 | A (157° C.) | A (187° C.) | A (97.2%) | A (0.54%) | A |
| Comparative Example 1 | 28 | C (178° C.) | A (189° C.) | A (98.5%) | A (0.46%) | A |
| Comparative Example 2 | 29 | A (151° C.) | B (177° C.) | B (94.8%) | B (1.13%) | C |
| Comparative Example 3 | 30 | C (178° C.) | A (186° C.) | A (96.3%) | A (0.52%) | A |
| Comparative Example 4 | 31 | C (178° C.) | A (185° C.) | A (96.6%) | A (0.66%) | A |
| Comparative Example 5 | 32 | B (166° C.) | A (187° C.) | B (93.1%) | C (2.11%) | B |
| Comparative Example 6 | 33 | C (178° C.) | A (186° C.) | A (96.3%) | A (0.52%) | A |
| Comparative Example 7 | 34 | A (148° C.) | C (174° C.) | B (93.2%) | B (1.12%) | C |
| Comparative Example 8 | 35 | C (178° C.) | A (185° C.) | A (98.2%) | A (0.43%) | A |
| Comparative Example 9 | 36 | C (178° C.) | A (189° C.) | A (97.2%) | A (0.49%) | A |
| Comparative Example 10 | 37 | C (178° C.) | A (186° C.) | A (96.3%) | A (0.52%) | A |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-212354, filed Oct. 28, 2015, which is hereby incorporated by reference herein in its entirety.

What is claimed is:

1. A toner comprising a toner particle containing a binder resin, a colorant and a crystalline resin, wherein
in viscoelasticity measurement in which the toner is heated from 20° C. to 120° C. at a ramp rate of 2.0° C./minute,
the loss elastic modulus G″ of the toner at 20° C. is from 1.5×10⁸ Pa to 1.0×10⁹ Pa,
in a temperature-loss elastic modulus curve obtained by plotting a temperature (° C.) on the abscissa and the common logarithm (LogG″) of a value obtained by dividing the loss elastic modulus G″ of the toner by a loss elastic modulus unit (Pa) on the ordinate, a shoulder appears at a temperature Tp in a range of from 30° C. to 45° C., and
in Curve 1 obtained by differentiating the temperature-loss elastic modulus curve once by the temperature, a minimum value of the Curve 1 in a range of 60° C. or more is from −0.30 to −0.15.

2. The toner according to claim 1, wherein in the viscoelasticity measurement, the loss elastic modulus G″ of the toner exhibits a maximum value in a temperature range of from 48.0° C. to 62.0° C., and this maximum value is from 6.0×10⁸ Pa to 3.0×10⁹ Pa.

3. The toner according to claim 1, wherein the crystalline resin has a melting point Tm (C) of from 55.0° C. to 85.0° C., and
the ratio of an endothermic peak area at 50° C. or less relative to an endothermic main peak area of the crystalline resin in a DSC curve obtained by differential scanning calorimetry is from 2.0% to 20.0%.

4. The toner according to claim 1, wherein the toner contains from 3.0 mass parts to 30.0 mass parts of the crystalline resin per 100 mass parts of the binder resin.
